(19) United States
(12) Patent Application Publication
(10) Pub. No.: US 2009/0290961 A1
(43) Pub. Date: Nov. 26, 2009

(54) PRODUCT PACKAGING SYSTEM AND METHOD

(76) Inventor: Macy Langston, St. Charles, IL (US)

Correspondence Address: Macy Langston, 7n396 Ridge Line Road, St. Charles, IL, 60175, US

(21) Appl. No.: 12/465,533

(22) Filed: May 13, 2009

Related U.S. Application Data
(60) Provisional application No. 61/052,880, filed on May 13, 2008.

(51) Int. Cl. B65G 61/00

(52) U.S. Cl. 414/222.01; 414/806

(57) ABSTRACT

Converting systems including stacking and casing modules are provided. Stacking modules permits rapid and reliable stacking of boxes having a wide variety of shapes and sizes, such as straight-line and auto-bottom boxes. Stacks may be formed with layers arranged in varying orientations, having varying numbers of boxes. Casing modules operate to load one or more stacks of product, which again may have varying shapes and sizes, into cases.

This application emanates from a previously filed provisional application dated May 13, 2008, application number 61052880

### TECHNICAL FIELD

The present invention relates generally to product packaging systems and methods. For example, some embodiments of the invention relate to systems and methods for stacking and packaging folded boxes, and particularly folded boxes that are irregularly shaped.

### BACKGROUND OF THE INVENTION

Automated material handling systems provide for the rapid stacking and/or packaging of generally-flat materials such as commercial and newspaper print materials and folded boxes or cartons. In the newsprint industry, the products (called signatures) are sections of printed magazines and books. These signatures generally have a rectangular or square shape and consist of thin sheets of printed paper. Signatures are typically stacked and then placed on a pallet for shipping to a bindery for binding or to the end customer. The stacking of signatures is generally easier to implement via automated material handling systems because the signatures are generally rectangular in shape, and consist of thin sheets of paper.

The converting industry prints and then folds and glues boxes such as those used for cereal, drink carriers and other packaging of all types. These boxes are frequently manufactured out of paperboard or corrugated cardboard. Once the boxes are folded they are typically placed either by hand or automation into a case for shipping to the customer. However, compared to signatures, folded boxes have many unique characteristics, such as irregular shapes, that must be addressed by any material handling system or process, such as the placement of glue lines, common irregular (i.e. not square or rectangular) shapes when folded, and varying thicknesses when folded.

Straight line boxes are boxes with a single glued seam running the length of the box. One common application for straight line boxes is for packaging of cereal products. An example of a straight line box is box 2, illustrated in FIG. 1. These boxes have longer straight edges on the sides and can be packed into a case by using existing automation. The automation takes the stream of boxes directly into the case. Examples of automation systems adapted to pack straight line boxes are those sold by the Bobst Group and Heidelburg, such as Heidelburg's J Pack system.

However, some types of boxes with irregular shapes are not even generally square or rectangular when folded, such as an L-shape. One example of such a box is called an auto-bottom. An example of an auto-bottom box is box 4, illustrated in FIG. 2. An auto-bottom typically has many layers when folded. When the box is opened or unfolded, the bottom is already formed without further gluing steps. Accordingly, when folded, the bottom of the box is typically substantially thicker that the top, which only includes the lid of the box. Auto-bottoms generally are packed in the case with the stacks alternating in direction to prevent damage to the flaps, to save space, and to promote stability of the packed product during shipping. This characteristic of being packed with materials in alternating directions is known as compensation.

Due to the shape and characteristics of auto-bottoms, many prior art packaging systems, such as the known Bobst and Heidelberg systems, are not adapted to automatically pack auto-bottoms or other products that require the product to be cross-packed or compensated into the case. In prior packaging processes, product that required compensation was typically packed into cases by hand. Thus, auto-bottoms are significantly more difficult to handle, stack and case than either signatures or straight line boxes.

### SUMMARY OF THE INVENTION

In accordance with one aspect of the invention, a method for creating a stack of folded irregularly-shaped products is provided. The method includes the step of sequentially receiving a plurality of folded irregularly-shaped products at an inlet, such as in a shingled stream of folded boxes or cartons. The method also includes the step of forming a plurality of layers from said products, each layer comprising a stack of one or more products in a common orientation. Each of the layers is then dropped onto a collecting table. In some embodiments, the collecting table can be rotatable. The collecting table can be rotated after each layer is dropped onto it, such as may be desirable to form a compensated stack. Alternatively or in addition, the collecting table can be rotated after a stack has been formed, thereby controlling the ultimate orientation of the stack. For auto-bottom products that will ultimately be handled manually, it may be desirable to orient the completed stack so that a long edge of the auto-bottom product faces outwards, or in a leading direction.

The plurality of layers can be formed by feeding the products into an upper chamber, and dropping each product through the upper chamber onto an intermediate collection surface. Optionally, during the process of feeding products into the upper chamber, upward or downward pressure can be exerted on one or more edges of each of the products to impart a curved cross-section on each of the products.

The step of dropping each product through the upper chamber onto an intermediate collection surface may optionally include the application of one or more streams of downwardly-directed air to a trailing edge of each product. Alternatively or in addition, one or more streams of upwardly-directed air can be applied to a leading edge of each product.

The step of dropping each product through the upper chamber onto an intermediate collection surface may include interim steps, including dropping a first portion of the products onto a preliminary collection surface that is positioned above the intermediate collection surface, to form a preliminary stack; dropping the preliminary stack onto the intermediate collection surface; and dropping a second portion of the products directly onto the preliminary stack, which at that point resides on the intermediate collection surface, to complete the formation of the layer. Alternatively or in addition, the intermediate collection surface can be indexed downwards from an initial position as product is dropped onto it, such as may be desirable for limiting the product drop distance of products while enabling a higher stack to be built.

For asymmetric product having a long side and a short side, the step of ejecting each product into an upper chamber can include the step of supporting a short side of the asymmetric product, during at least a portion of the period in which the long side of the product is not yet fully within the upper chamber.

Systems for stacking a plurality of folded irregularly-shaped products into a stack is also provided. One example of such a system includes an inlet leading to an upper chamber through which a stream of folded irregularly-shaped products is fed. A gapper is provided through which the stream of folded irregularly-shaped products is also fed. The system further includes one or more horizontally-disposed collection areas within the upper chamber, the collection areas positioned below the inlet and spaced vertically with respect to one another. In some embodiments, a rotatable collecting table is positioned beneath the one or more collection areas.

In some embodiments, the gapper includes a pivot bar, a plurality of claws mounted on the pivot bar, and a pneumatic cylinder pivotally connected to the pivot bar for movement thereof in response to movement of the pneumatic cylinder. The gapper can further include a plurality of driven gapper rollers distributed across a feed path of the plurality of boxes, on the downstream side of the plurality of claws. In some embodiments, the diameter of each of the plurality of driven gapper rollers is about 50 millimeters.

The system may also include a stabilizer located downstream of the gapper. The stabilizer may include one or more stabilizer rollers positioned adjacent to the product stream, each roller being adjustable in elevation relative to the product stream. In some embodiments, the one or more stabilizer rollers are positioned along the bottom side of the product stream. The stabilizer rollers can be distributed across the width of the product stream. One or more stabilizer rollers positioned towards one or more outer edges of the product stream can be positioned at a raised elevation relative to the middle of the product stream. Optionally, the stabilizer rollers can be surrounded by one or more stabilizer belts, which are driven by the stabilizer rollers. For auto-bottom boxes having a long edge and a short edge, a stabilizer roller positioned nearest the long edge of the auto-bottom boxes can be positioned at a raised elevation relative to other stabilizer rollers.

Each of the one or more collection areas can include pneumatically-driven horizontally-disposed grid fingers adapted for insertion into and removal from the upper chamber. In some embodiments having first and second collection areas, the first collection area grid fingers are positioned at a predetermined elevation, and the second collection area grid fingers are mounted to a movable member for indexing in a vertical direction. A back plate can be positioned perpendicularly and proximate to a trailing edge of at least one of the collection areas. An air plenum can be provided within the back plate, connected to one or more air vent openings angled downwards out of a surface of the back plate, such as may be utilized to exert downward force on the trailing edge of a carton falling within the upper chamber. In addition or in alternative to such a back plate, a front plate can be positioned perpendicularly and proximate to a leading edge of at least one of the collection areas. An air plenum can be provided within the front plate, connected to one or more air vent openings angled upwards out of a surface of the front plate, such as may be utilized to exert upward force on the leading edge of a carton falling within the upper chamber.

A carton support bar can be provided, extending approximately horizontally from a location proximate the inlet, into the upper chamber. For products that are L-shaped auto-bottom boxes having a long side and a short side, the carton support bar can be laterally positioned proximate an area through which the short side of the L-shaped auto-bottom boxes pass. Accordingly, the L-shaped auto-bottom boxes can be maintained in a generally horizontal orientation while being fed into the upper chamber.

A vertically-disposed ejector surface can be positioned proximate one side of the collecting table, the ejector surface mounted for movement across the collecting table for pushing stacked product off of the collecting table. Also, a guide plate can be positioned proximate one side of the collecting table, the guide plate forming an opening through which the stack is pushed.

A method for loading stacks of folded, irregularly-shaped products into a case is also provided. The method includes the step of positioning a case proximate a guiding platform on which a stack of products is placed. A compression member is extended into the case, above a level of product previously placed into the case. The case is moved upwards relative to the compression member to compress the product previously placed into the case. The stack of product is pushed into the case, above the compression member, and the compression member is withdrawn from the case.

The method may also include the step of extending support forks into the case, above the level of product previously placed into the case, prior to the step of pushing the stack of products into the case. The support forks are then withdrawn from the case, after the step of pushing the stack of product into the case. The stack of product can be pushed into the case, above the compression member, by moving a pushing member from a resting position proximate one side of the guiding platform, across the guiding platform, and then retracting the pushing member to the resting position via a path outside of the guiding platform.

A system is also provided for loading stacks of folded irregularly-shaped products into a case. The system includes a case positioning assembly for positioning a case horizontally and vertically in line with the guiding platform to receive stacks of products. A pushing assembly is provided for pushing the stacks of products along a guiding platform into the case. A compression member is insertable into and removable from an interior of the case to compress product previously inserted into the case through upward translation of the case while the compression member resides within the interior of the case. The case positioning assembly may include a case supporting surface that is inclined downwards from an open side of the case, such as by an angle of about 10 degrees.

The compression member may be a fork structure having a plurality of prongs. The system may also include a flexible support fork mounted for extension into and removal from the case above the compression member. The flexible support fork can extend across the inside of the case by a variable distance, and in some embodiments may extend across substantially the entirety of the inside of the case. The flexible support fork can be made from strips of spring steel or polyoxymethylene.

The pushing assembly may include a pushing member which is mounted for lateral repositioning relative to the guiding platform. The pushing assembly may also include a pushing member residing initially in a resting position proximate one side of the guiding platform. An ejection path extends from the resting position across the guiding platform, along which the pushing member moves while pushing products along the guiding platform into the case. A retraction path, different from the ejection path, is also provided, along which the pushing member moves while returning to the resting position.

### BRIEF DESCRIPTION OF THE DRAWINGS

FIG. 1 is a straight-line box.

FIG. 2 is an auto-bottom box.

FIG. 3 is an elevation of a stacker module.

FIG. 4A is an expanded elevation view of a portion of a stacker module including shingle stream spacing structures.

FIG. 4B is a perspective view of a portion of a stacker module including shingle stream spacing structures.

FIG. 5A is an elevation of a gapper assembly.

FIG. 5B is a perspective view of a gapper assembly.

FIG. 5C is an isolated perspective view of a gapper assembly.

FIG. 5D is a perspective view of a portion of an upper chamber.

FIG. 5E is a perspective view of a lower chamber.

FIG. 6 is a perspective view of a case loading system.

FIG. 7 is an elevation of a case loading operation during a first stage.

FIG. 8 is an elevation of a case loading operation during a second stage.

FIG. 9 is an elevation of a case loading operation during a third stage.

FIG. 10 is an elevation of a case loading operation during a fourth stage.

FIG. 11 is an elevation of a case loading operation during a fifth stage.

FIG. 12 is an elevation of a case loading operation during a sixth stage.

FIG. 13 is an elevation of a case loading operation during a seventh stage.

FIG. 14 is an elevation of a case loading operation during an eighth stage.

FIG. 15 is an elevation of a case loading operation during a ninth stage.

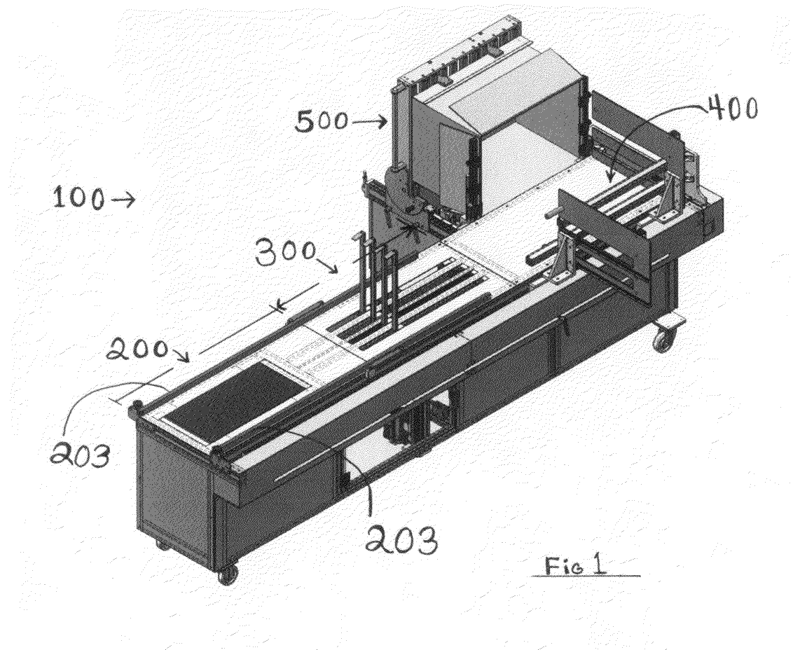

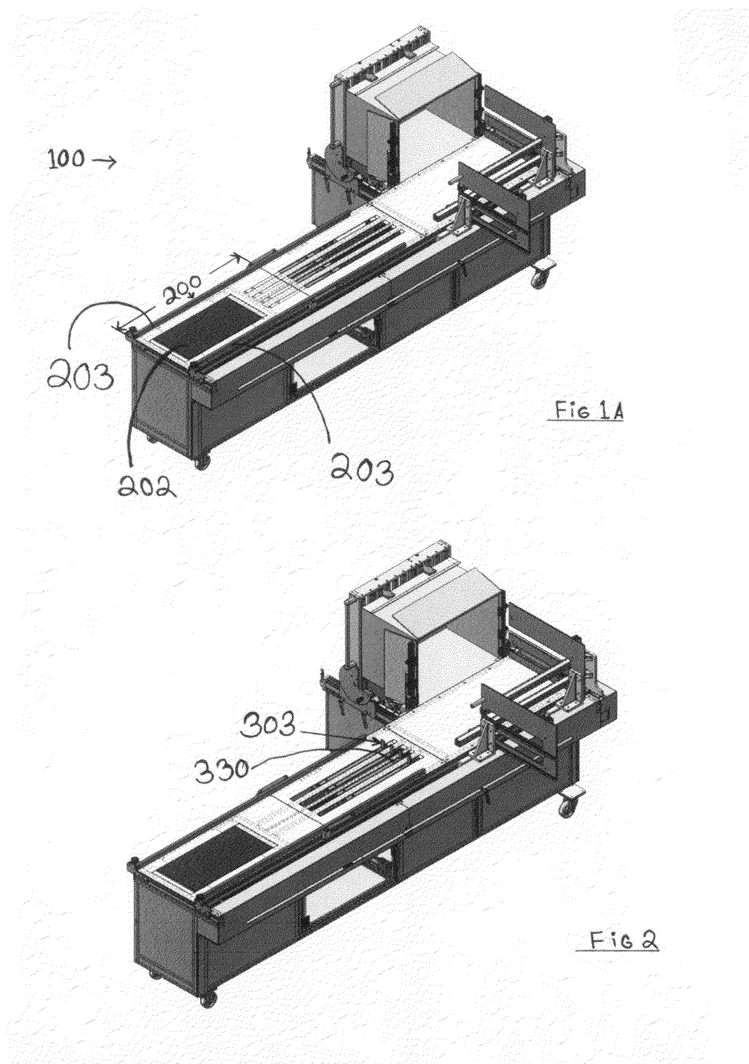

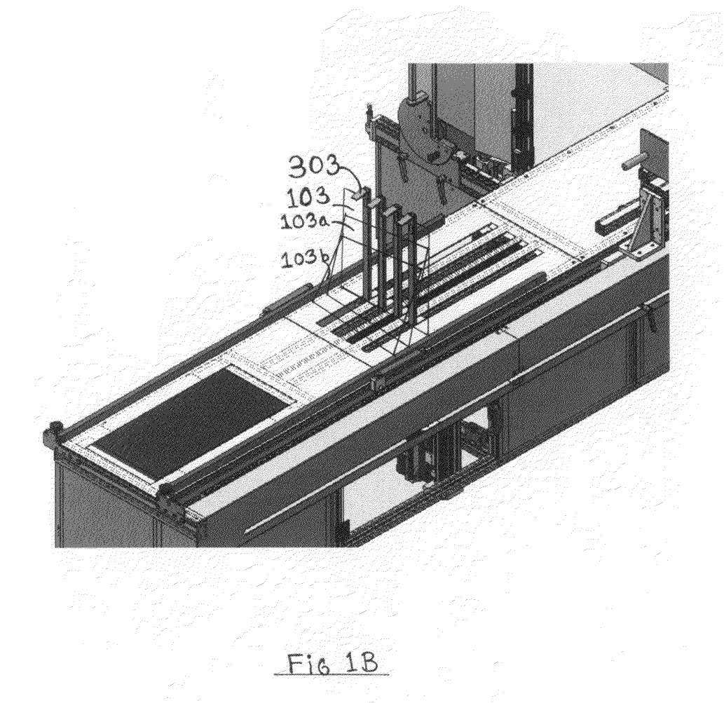

### DETAILED DESCRIPTION

While this invention is susceptible of embodiment in many different forms, there are shown in the drawings and will herein be described in detail, certain specific embodiments with the understanding that the present disclosure should be considered as an exemplification of the principles of the invention and is not intended to limit the invention to the embodiments so illustrated or described.

The present system enables the automatic stacking and/or casing of boxes. In some embodiments, boxes can be automatically placed into a case, while compensating the orientation of the boxes so as to maximize the efficiency and stability with which the boxes are placed in the case. In other embodiments, the system can automatically stack the boxes and present a compensated stack that can be readily packed into a case by hand. Embodiments of the present system can stack and pack both straight line product as well as irregularly shaped product, such as auto-bottom and auto-lock. The capability of variably handling both straight line and irregular product can be particularly beneficial to small and mid size converters, who may wish to run all types of boxes on any given automation system, thereby providing a greater and more rapid reasonable return on investment, particularly to the extent that labor savings may not be split by the job mix.

The present system can also be advantageously employed in connection with the stacking and casing of product that does not require compensation, such as straight line boxes. In such applications, the entire load can be rotated just prior to casing, such as rotation by 90 or 180 degrees, to change the orientation of how the load is put into the case. As a result, the product can be cased to accommodate any arbitrary product orientation that may be desired. This capability avoids the incorporation of costly upstream auxiliary equipment that is commonly required in other packing systems to change the orientation of the product.

Although the use of automation to place boxes directly into the case is preferred in many applications, in other applications it may be desirable to provide for hand packing. For example, some users may require boxes to be packed in patterns that are implemented more economically by hand. However, even in hand-packed applications, the stacking of the product and presentation of the stacked product to the operator in a desired orientation can save considerable labor—particularly when compared to prior methods used for auto-bottom boxes, which require scooping and all compensation of the boxes by hand. The creation of a stack that is then presented to the packer in an ergonomic orientation and fashion can reduce the risk of back and wrist injuries to the packer by avoiding certain manual activities that may otherwise be required.

In some embodiments, the system includes two main operations: collecting the product into stacks and then positioning the stacks within a case. As discussed further hereinbelow, it is understood that these two operations can be beneficially utilized together or separately.

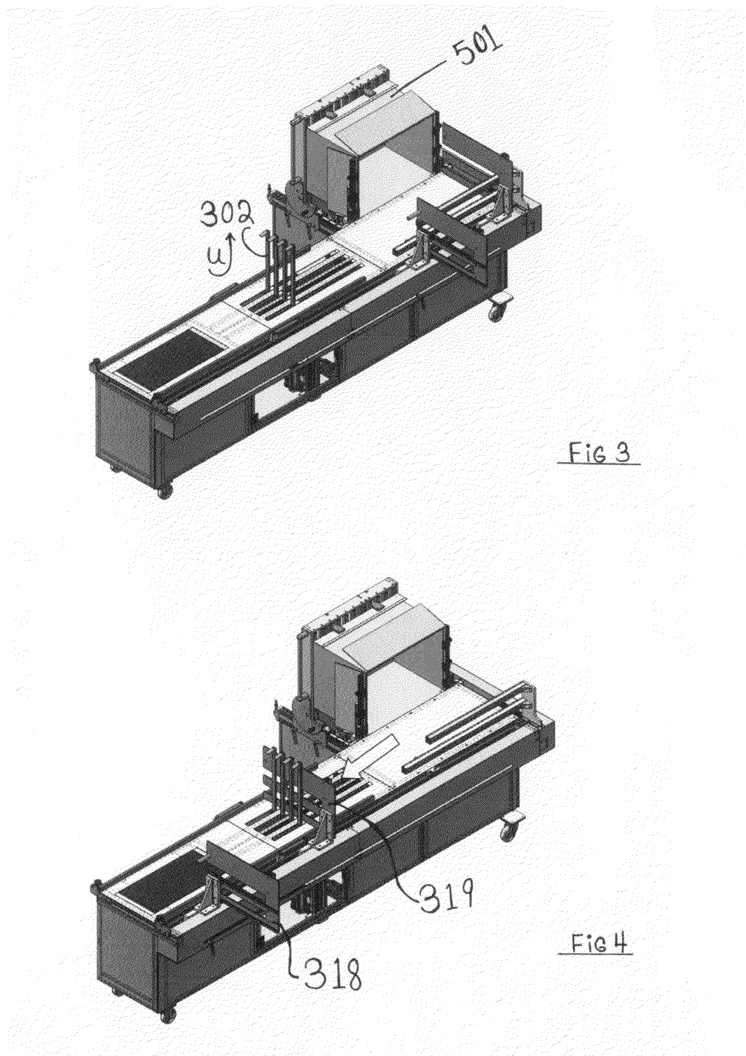

The collecting operation is generally performed at stacker module 6, which is illustrated in elevation in FIG. 3. Stacker module 6 features a conventional welded frame construction. A shingled stream of package product is taken into the infeed 10 at the front end 12 of the product layer collector, at which point it passes divert gate 14. Divert gate 14 can be used for several purposes. During start up, divert gate 14 can be opened to that the “make ready” waste is dumped directly into a trash bin, thereby saving labor that might otherwise be required for workers to scoop product up manually. During operation of stacker module 6, divert gate 14 can be used to divert product. For example, optical detectors such as infeed light barriers can be provided in front of divert gate 14 to detect whether incoming product is skewed or otherwise improperly aligned, such as might occur unintentionally at the output of a preceding glue line operation. If a misaligned product is detected, divert gate 14 can be opened for a period of time, such as for several seconds, to dump the misaligned box or boxes that could otherwise cause a jam in subsequent portions of the stacker module. In some embodiments, such operation of divert gate 14 may improve the run time and net yield of the system.

Infeed 10 operates to bring the product up to the upper chamber and to create the desired shingle stream spacing. Infeed 10 includes conveyor system 16, as well as devices and software used to create and maintain precise shingle stream spacing. Conveyor system 16 can be implemented using standard conveyor technology. In some embodiments, conveyor system 16 can be implemented using belts above and below to drive the product up. In other embodiments, a single belt, typically below the product, may also be used. Use of a driven top belt permits infeed 10 to have a greater incline. However, use of a single, wide belt may be particularly beneficial for auto-bottom product, to trap and control the product, in view of the variation in product thickness from side to side. Preferably, infeed 10 is adjustable in height.

Also involved in the operation of infeed 10 are devices and software used to create and maintain precise shingle stream spacing. The shingle stream coming from the glue line can be thick, with typical spacing between product leading edges of one-quarter of an inch. It may be desirable to increase shingle spacing for consistency and smooth operation of the stacking process. The desired shingle spacing can be obtained by running infeed conveyor 16 at an increased speed relative to preceding operations. The precise speed of conveyor 16 is calculated via computer software, based on the speed of the preceding glue line compression belt (not shown).

A software user interface is provided on control panel 17 through which the operator sets the desired spacing digitally, in response to which the corresponding speed of conveyor 16 is determined and adjusted. Control panel 17 is mounted on boom 18, so that its position can be adjusted as desired by the operator.

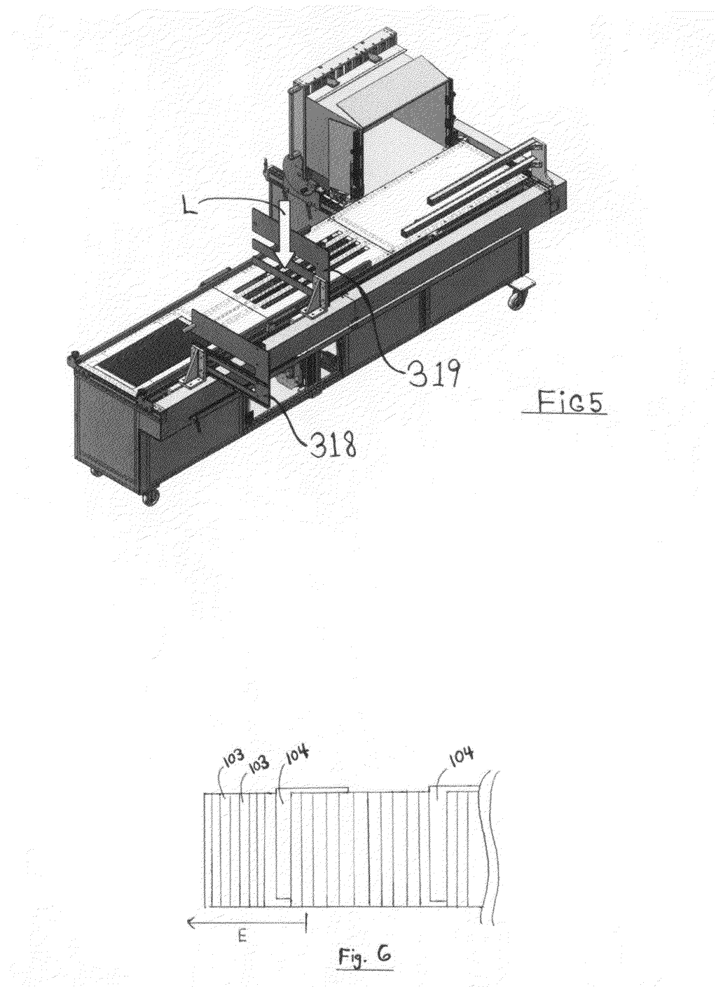

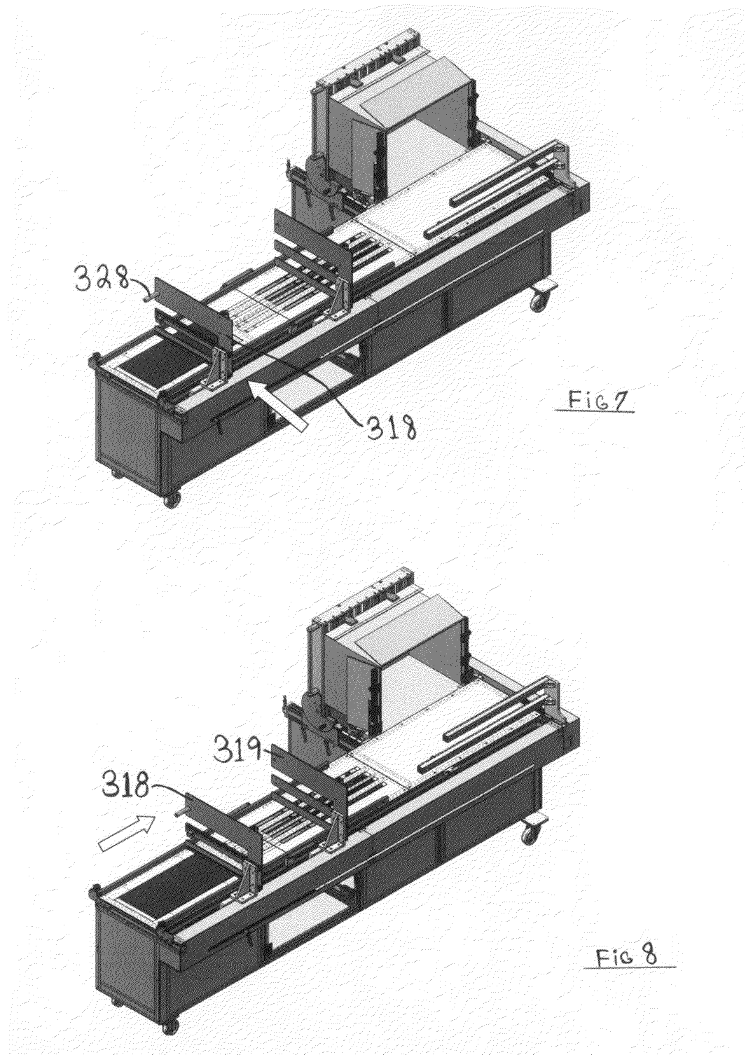

Additional features can be provided to assist with separation of adjacent shingles, which are illustrated in further detail in FIGS. 4A and 4B. For example, air can be provided at the nip point. Additionally, a guide plate can be provided to keep the product from floating. Finally, hold down rollers 19 can help hold back the slower-speed product. Together, these devices can assist in creating clean and consistent wider shingle stream spacing.

Referring again to FIG. 3, laser counter 20 is provided to count the products and trigger the separating unit (gapper) 22. Counter 20 can be of conventional construction, of a type that is commercially available and used in multiple industries for counting of printed product.

Gapper 22 is used to create more space between the last product in one stack and the first product of the subsequent stack, facilitating further separation of the product into separate stacks downstream. In the converting industry, conventional stream gapping typically occurs at relatively slow rates, and reduces the cycle time of the unit. While the function of the gapper is to create space for upper grid fingers to be interposed between products, preferably it will create such a gap without backing up the stream and creating a thick grouping of boxes for the start of the next stack. These types of thick groupings can lead to product damage and stacking module jams.

High speed gappers for signatures are available in the newsprint industry from companies such as Rima, Mueller and Gammerler. However, such gappers typically use a single claw mounted directly to a pneumatic cylinder, roughly centered on the signature stream. While such a gapper can operate effectively in connection with square, symmetrical products such as signatures, such single-claw gappers may be unreliable for use with irregularly-shaped products, such as auto-bottoms, because the off-center moment of inertia causes the product to rotate when caught by a single, centered claw.

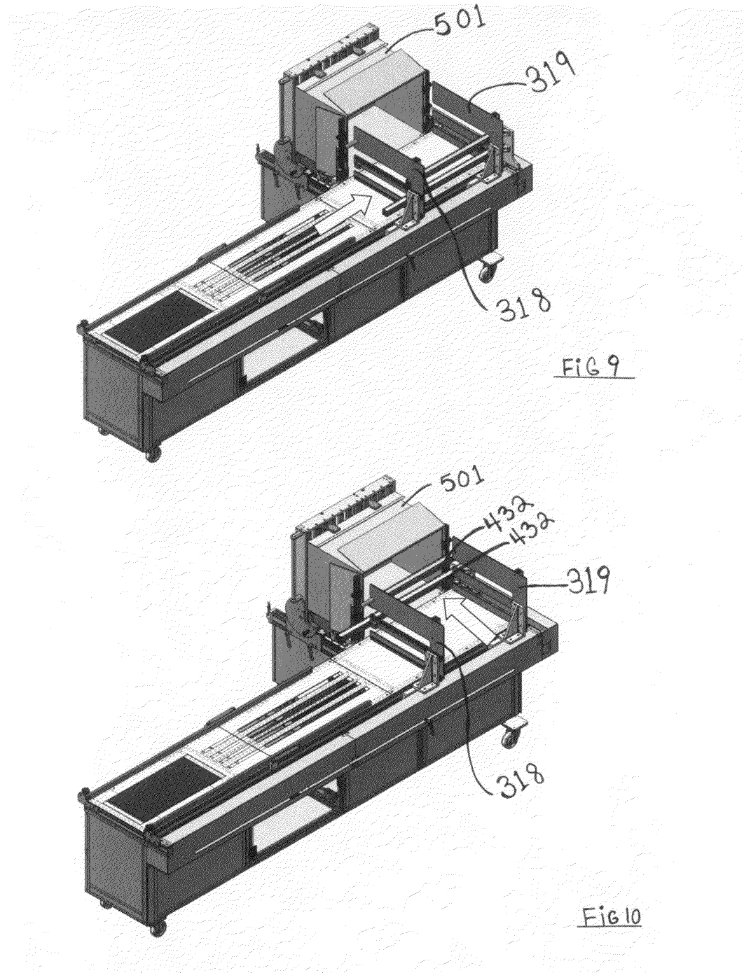

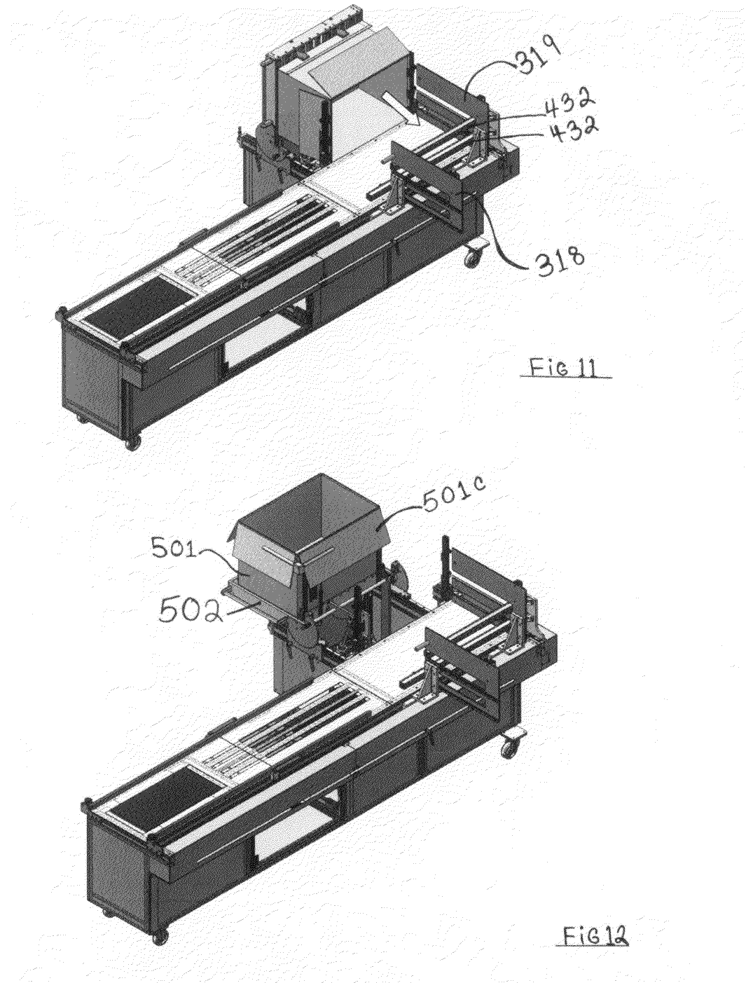

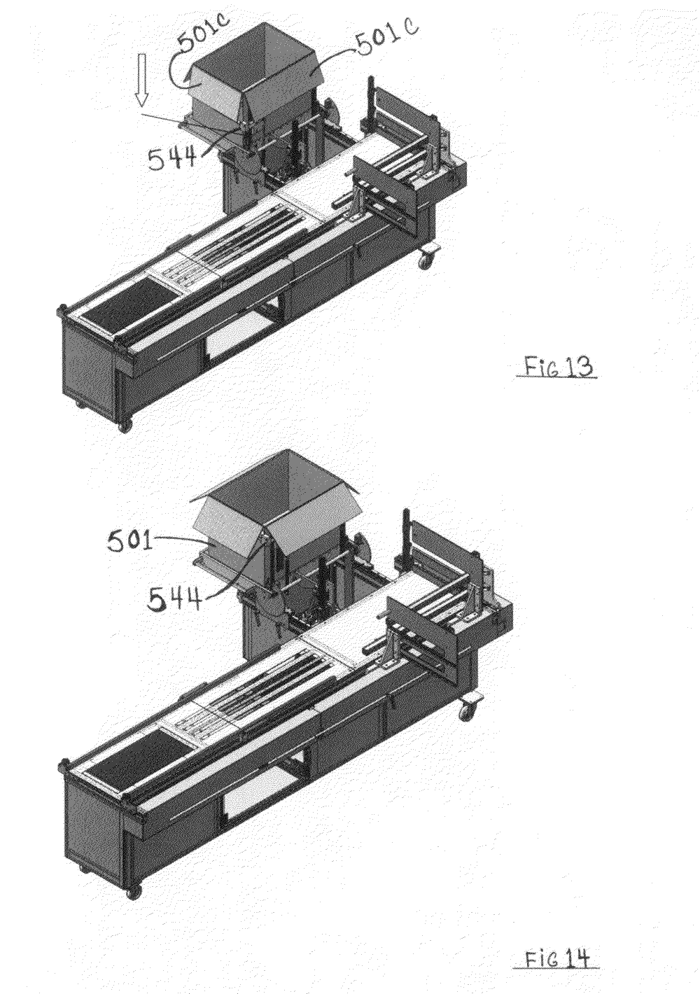

However, gapper 22 (illustrated in detail in FIGS. 5A, 5B and, in isolation, FIG. 5C) provides three wide fingers or claws 23 mounted to pivot bar 24 that is then moved by pneumatic cylinder 25. While claws 23 are typically mounted in lateral alignment with one another, the elevation view of FIG. 5A depicts the claws in both lowered position 23A and raised position 23B. Since the product is in a stream when it enters gapper 22, the last box of the proceeding stack is partially underneath the first box of the next stack, which is held back when claws 23 are placed into a lowered position. Gapper fingers or claws 23 are preferably formed from spring steel with a hooked end, adapted for engaging and temporarily stopping movement of incoming product. While the use of flexible fingers or claws can facilitate fast processing and reduced costs in some applications, in other embodiments, gapper fingers or claws 23 could also be formed from solid plates, or belts on rollers.

Gapper rollers 26 are positioned after claws 23, and operate to pull the product out of gapper 22. Preferably, gapper rollers 26 are greater in diameter than rollers used in conventional gappers for newsprint signatures. For example, while conventional gapper rollers may be about 25 millimeters in diameter, in some embodiments, gapper rollers 26 are approximately 50 millimeters in diameter. Because many typical cartons are relatively thick and compressible in the vertical direction when folded, the large roller diameter can be valuable to the extent that it provides increased mechanical advantage to promote lifting of the roller while compressing cartons and driving cartons forward. By providing an increased diameter, it has been found that the ability of gapper rollers 26 to feed thick product, such as the leading edge of an auto-bottom, without any stoppage of the product stream is improved, thereby improving the accuracy and reliability of the gapping operation.

In some embodiments, gapper rollers 26 employ soft plastic or rubber rollers to be able to effectively grip and pull a box forward. Gapper rollers 26 preferably include multiple rollers, and most preferably four rollers, spaced across the span of the feed path, thus improving the ability of gapper rollers 26 to evenly catch and pull forward the entire leading edge of products having a variety of shapes and sizes.

Hold down strips 27 are also provided, to help fan the product back that is being held back at gapper 22. Hold down strips 27 can be comprised of metal, and help keep a pile from building up that would clear its way through gapper rollers 26 or subsequent stabilization rollers 43.

In some embodiments, gapper 22 can be driven by one or more motors and/or timing belts. Gapper rollers 26 can also be operated via a system of belts and rollers.

Using a construction as described herein, gapper 22 can be configured to catch the leading edge of a box at production speeds exceeding 100,000 boxes per hour. By using gapper 22 to create a very quick gap and facilitate subsequent separation of stacks, the rate of speed at which stacking module 6 can operate may be increased.

While inlet assemblies such as infeed 10 and gapper 22 are described in terms of their operation receiving a shingled stream of product, it is understood that in other embodiments, those assemblies could readily process a sequence of individual, separately-received cartons.

After exiting gapper 22, the boxes are stabilized by stabilizer 40 before being fed into an upper chamber, where they are dropped into a pre-collecting area. Stabilizer 40 includes four belts 41 over rollers 42 that are underneath the stream and distributed laterally across the entry to the upper chamber. One or more of the belts can be rotated upwards, as desired, to bend the cartons as they enter the upper chamber. Meanwhile, stabilizer rollers 43 hold cartons down, against belts 41 and rollers 42. For example, in some embodiments it may be desirable to adjust the outermost rollers upwards relative to the middle rollers, thereby imparting a slight U-shaped cross-section to the product. By creating a bow in the product, the longitudinal rigidity of the product can be increased, inhibiting the leading edge of the product from dipping as it enters the chamber, thereby providing improved stabilization as each carton is driven to the back of the upper chamber before descending.

While stabilizer 40 can be implemented using four rollers with belts, it is contemplated and understood that other structures can likewise be utilized. For example, without limitation, rollers without belts may be used, and differing numbers of rollers and/or belts can be used.

While various stabilizing technologies are known for use with newsprint, such as the use of bars to push up on the paper or rollers, stabilizer 40 provides several features that are particularly beneficial for use with folded boxes. For example, stabilizer 40 can vary the amount of pressure applied to the product, which can be important for dealing with the variety of box thicknesses found with irregularly shaped product. Also, the plurality of independently-adjustable rollers and/or belts provided in some embodiments of stabilizer 40 enables engagement of one side of the product, leaving the other side free. This single-sided engagement can be particularly beneficial for auto-bottom product, which is typically L-shaped. The auto-bottom flap, which typically comes last, can otherwise tend to drive the product into the chamber at an angle, causing jams. By lifting only one stabilization belt on the long side where the flap is positioned, rotation of the box can be avoided.

Following ejection from gapper 22 and stabilizer 40, product is fed into the upper chamber and initially collected in a pre-collecting area, on upper grid fingers 50. Momentary collection of product on upper grid fingers 50 may permit better control of the product orientation during subsequent dropping of the product into further collection areas.

Specifically, upper grid fingers 50 are located in the vertical space through which the boxes drop. Upper grid fingers 50 activate when gapper 22 operates to induce a gap in the product stream. By permitting a small amount of product to build up on upper grid fingers 50, additional opportunity is provided for product below to clear its descent into lower chambers. While the use of forks moved by pneumatics is known in the newsprint industry, upper grid fingers 50 are mounted and controlled differently from typical forks for newsprint applications. Newsprint industry forks are typically mounted directly to a pneumatic cylinder. However, upper grid fingers 50 are fabricated within a construction that permits the grid fingers to be thinner, so that they take up less vertical space, thereby reducing the drop height from one stage to the next.

The construction of upper grid fingers 50 is illustrated in detail in FIG. 5D, in an embodiment featuring three grid finger collection areas. Upper grid fingers 50 are mounted to block 51. Block 51 is in turn mounted on round hollow shaft 52, which is moved by a pneumatic cylinder (not shown).

In addition to providing a grid finger construction having a low vertical profile, block 51 can pivot on shaft 52. By providing such a pivoting mounting structure, the angle of upper grid fingers 50 can be readily set as desired. Upper grid fingers 50 can also be removed from block 51, which may be desirable in operations that might otherwise catch certain auto-bottoms or other odd shaped products and damage them.

Because upper grid fingers 50 can be pivoted and/or removed, additional flexibility is provided in their operation. In typical commercial printing industry systems having two stages of grid fingers, product builds on a lower set of grid fingers and is not allowed to build above the first stage forks. However, stacking module 6 permits product to build above upper grid fingers 50 for creation of a larger stack to move to later stages. In some converting applications, by providing larger first stage and second stage stacks, the cartons do not fall as far, thereby reducing the opportunity for twisting, flipping and jams.

In addition to, or in alternative to, building product on the upper grid fingers based on the number of products counted by counter 20, the first stack can also be built up until reaching a sensor, which detects when the product on upper grid fingers 50 exceeds a desired stack height. In other embodiments, upper grid fingers 50 can be actuated by a timer, so that product builds on upper grid fingers 50 for a desired period of time. Accordingly, stacking module 6 provides an operator with a number of different ways to control how stacks are built.

Typically, stacking module 6 starts with the upper grid fingers in. Certain products, such as an auto-bottom, may be prone to falling sideways due to its asymmetric folded configuration, since the side without the box lid is released from the stabilization rollers first. If such a product is allowed to fall directly to the second set of fingers, the product may be prone to overrotation, such that the leading edge may fall between the lower grid fingers. By starting with the upper grid fingers closed, a small number of boxes can be built on the upper grid fingers, which boxes can then be dropped down as a cohesive stack. Such a mode of operation can be implemented by triggering upper grid fingers 50 to pull out after sensor 53 sees the first product go by.

Another mode of operation can be employed, particularly for small boxes or thin boxes. For such applications, the distance that the product drops to a lower level is greater in proportion to the size of the product. Therefore, sensor 53 can be positioned to open upper grid fingers 50 only when a stack has built up on upper grid fingers 50 to a desired height. Thus, mini-stacks of greater size can be dropped together, to minimize the likelihood of product rotation during a dropping operation.

Lower grid fingers 55 provide a secondary collection and control point before product drops to collecting table 60 below, controlling the product orientation and ensuring that each individual product drop distance is appropriately limited. Vertical format adjustment assembly 65 controls the positioning of side joggers forming sides of the upper chamber, to accommodate different product sizes and to promote precise alignment of products within the upper chamber. Vertical format adjustment assembly 65 can be adjusted during operation to optimize operation for any particular carton size and shape. In some embodiments, vertical format adjustment assembly 65 may be actuated using timing belts, while in other embodiments, servo or stepper control can be provided to aid in reducing setup time.

Product format axial assembly 70 provides additional degrees of adjustment based on the size of the desired product. Product format axial assembly 70 utilizes timing belts, servos and/or stepper control to adjust upper chamber front plate 56 and back plate 57 (shown in, e.g., FIG. 5D), and can be controlled during operation. By controlling the position of vertical format adjustment assembly 65 and product format axial adjustment assembly 70, a wide variety of product sizes can be accommodated. For example, in an exemplary embodiment, product sizes ranging from four inches square, to twenty inches square, can readily be accommodated.

Lower grid fingers 55 are opened when upper grid fingers 50 are closed, and at a stage based on the stack count, and/or the stack height as detected by a sensor. While the levels of upper grid fingers 50 and lower grid fingers 55 may be static in some embodiments during a particular stacking operation, in other embodiments, the grid finger elevation may vary during the course of a stack formation. For example, in one exemplary embodiment, upper grid fingers 50 can be removed or maintained in an open configuration. Lower grid fingers 55 can be initially adjusted upwards to minimize the distance that an initial product must descend to reach them. As product is stacked, lower grid fingers 55 are indexed down, enabling the formation of a stack while still maintaining the product drop distance within desired limits. When the stack reaches a desired level, lower grid fingers 55 can be opened to transfer the stack to a lower chamber, then returned to a desired position for collection of a new stack. In this manner, a single set of forks or fingers can be employed, rather than separate upper and lower sets.

While the system of FIG. 3 utilizes two collection areas formed from upper grid fingers 50 and lower grid fingers 55, in other embodiments, it is understood that differing numbers and configurations of collection areas can be employed. For example, the upper chamber illustrated in FIG. 5D features three collection areas, formed from upper grid fingers 50, middle grid fingers 50D and lower grid fingers 55. Partial stacks can be formed sequentially on fingers 50, 50D and 55, during their descent through the upper chamber. Embodiments featuring three collection areas, such as that of FIG. 5D, or even additional numbers of collection areas, may be desired to help limit undesired product rotation during descent by limiting the distance of each individual drop. This can be particularly useful in certain applications, such as those featuring long upper chambers to accommodate larger stacks, or in applications in which collection areas do not index downwards during stack formation.

Other features can also be provided within the upper chamber to control the descent of product through the chamber. For example, air streams can be provided within the upper chamber to control the product descent, particularly for unevenly-weighted products such as typical auto-bottoms. For example, many auto-bottom product streams feature a product leading edge that is significantly thicker, and therefore heavier, than trailing portions of the product. To balance such a product during descent, front plate 56 includes a vertical air plenum with air holes directed upwards at an angle, thereby partially supporting the heavy leading edge of a product such as an auto-bottom. Meanwhile, back plate 57 includes a vertical air plenum with air holes pointed downwards at an angle, helping maintain the product in a substantially horizontal orientation while it drops.

In some applications, such as irregularly-shaped auto-bottom applications, it may also be desirable to provide carton support bars. Carton support bar 58, illustrated in FIG. 5A and FIG. 5D, is configured to match the shape of an irregularly-shaped product, and moved into the upper chamber as each product is moved into the chamber. For example, for an L-shaped auto-bottom, the carton support bar can be configured to match the shape of the cut-out portion. Accordingly, the short side of the L-shaped auto-bottom is supported during the period in which the long side of the auto-bottom continues to be ejected into the upper chamber. Such a carton support bar can operate to maintain the carton in a substantially horizontal orientation, at least until the cut-out portion has passed into the chamber, thereby potentially reducing carton jams and improving stack quality.

When the required number of cartons per packaged layer has been reached, second set of grid fingers 55 opens and deposits the layer in the open collecting table 60 below. The products are contained on the table by side doors 75 and rotated an appropriate amount (e.g. by 180 degrees) when compensation is required, by means of turn table assembly 80. For product requiring compensation, as layers of product are collected on second set of fingers 55 and dropped onto collecting table 60, the cycle of rotation repeats for each layer. The amount of product dropped and when it is turned can be varied as needed. However, it should be understood that the table turn is not required for product which does not need compensation. Alternatively, for product not requiring compensation, the turntable can still be employed for rotating a completed stack into a desired orientation before placement into a case.

Preferably, collecting table 60 is of universal design, running the full width between side doors 75 to optimally support the product, prevent product jams and guide the product during subsequent movement into a case. Once a completed stack is formed on collecting table 60, side doors 75 are opened. Ejector 85 can then be used to move the finished bundles either into a corrugated case 90 (FIG. 6), as part of a case loading step, or onto a table attached to the stacker for manual case loading. Moreover, one or more of side doors 75 can be positioned so as to contact the product stack, thereby helping guide the product as it is moved off of collecting table 60, and into case 90 or a separate table.

In other embodiments, guide plates can additionally or alternatively be employed to further constrain movement of a product stack as it is moved out of collecting table 60 into case 90 or a separate table. Preferably, the guide plates are oriented with a slight angle inwards towards the vertical edge of the case, to help funnel the boxes as they are pushed into the case. Guide plates can also operate to help support and jog smaller boxes that have to be pushed further to reach the case. Such guide plates can be particularly advantageous in auto-bottom applications, in which only three corners are otherwise typically supported.

In some applications, collecting table 60 rotates 180 degrees between each stack, so that the direction of each stack is alternated. However, any desired amount of rotation, up to and beyond 360 degrees, can also be implemented.

Collecting table 60 can also control the orientation of a stack (regardless of whether one or more layers within the stack are compensated) by rotating the completed stack into a desired orientation before the stack is ejected. This is an option that the operator can select through operation of control panel 17 while running the unit.

Rotation of a completed stack can be beneficially employed for a variety of circumstances. For example, in some orientations, a product feature such as a glue seam or auto-bottom flap may be prone to catching on the edge of a carton while a stack is pushed over into a carton during a casing operation. By being able to rotate the entire stack again when desired, stacker module 6 can control the product orientation so that, for example, the product being pushed over may be directed at a downward angle, such that it won't interfere with any edge.

Controlled orientation of a product as cased may also have value to the end user of the cased product. For example, a subsequent user of the product may have to take the boxes out of the case to feed into some other packaging operation. Control of product orientation with a case permits customers to customize the product packaging for each customer's desired application. By providing cased product in an optimal orientation for a particular customer, the customer can avoid the expense, complexity and reliability impact that might otherwise be incurred to automatically turn the cartons in the customer's subsequent production stream.

When stacker module 6 is configured to eject stacks to a table for manual packing into a case, control of stack orientation can also be beneficial. For example, it may be substantially easier for an operator to pick up and pack an auto-bottom when grabbing the auto-bottom from the long side of the L-shape. By rotating the completed stack so that this side is oriented towards an operator, the ergonomics and cycle time of the operation is improved.

In some embodiments, collecting table 60 is multi-positional. For example, when product is being dropped from the upper chamber, and/or while compensating layers within a stack, collecting table 60 can be placed into an elevated position. Raising collecting table 60 to an elevated position when product is being dropped from the upper chamber can reduce the drop height. Collecting table 60 can then be lowered prior to ejection of the stack. Lowering of collecting table 60 during an ejection operation can also provide increased clearance between the upper and lower chambers during operation of a pushing arm.

Multiple positions may also operate to accommodate an angle of the compression forks and the product support forks. Because the forks are disposed at an angle, when the forks are retracted, or if they are lengthened for larger product, the back of the forks could potentially break the plane of rotating collecting table 60, thus causing a collision. Although such a collision could optionally be avoided by prohibiting retraction of the forks during a rotation operation, or by moving the casing unit away from the stacker and making the fork angle closer to parallel with collecting table 60, such adjustments could increase operation cycle time since the opportunities for pushing and dropping product would become dependent on the action of the casing unit. Alternatively, if the stacker is moved further away from the pusher, cycle time could increase, and the risk of damage to the front of the boxes during the compression cycle could increase when the fork angle changes relative to the product.

In some embodiments, it may be desirable to provide stack gates at the lower chamber outlet to maintain control of the stack height as it is pushed out of the lower chamber and into a case. Stack height can be detrimental to efficient packing of product because, for many products, a significant amount of air space is introduced into the stack when initially formed. In other terms, the stack becomes fluffy, as formed on collecting table 60. In a subsequent casing operation, described in detail below, the stacks can be subsequently compressed after placement into a case, to reduce the amount of airspace within the case. For example, with certain products, a stack which measures eight inches in height as formed on collecting table 60 can be readily compressed to five inches within a case. However, as a case nears a state of being filled, circumstances may arise in which the remaining space in the case is sufficient for insertion of an additional compressed stack, but insufficient to permit clearance of a fluffy stack as formed on collecting table 60.

Therefore, in order to maximize the efficiency with which cases can be packed, stack gates can be provided at the outlet of the lower chamber. For example, FIG. 5E provides a perspective view of a lower chamber having stack gates 62. In the embodiment of FIG. 5E, stack gates 62 are thin strips of spring steel, positioned on either side of the lower chamber, pivotally mounted towards their tops. As a first stack is pushed out along collecting table 60, stack gates 62 are rotated upwards, so that they extend partially into an adjacent case. As an adjacent case is filled and indexed downwards (as described in more detail below), stack gates 62 remain partially within the case. As a case approaches a full state, stack gates 62 contact the upper rim of the case, forming an angled guide which can operate to compress a stack as it is pushed into the case. When a full case is subsequently lowered for removal, stack gates 62 pull out of the case and hang vertically until another stack is pushed into a new case. In this way, stack gates 62 help ensure that a case can be filled completely, despite airspace that may be present in a stack formed on collecting table 60.

FIG. 6 is a perspective view of a case loading system 100 capable of automatically loading finished bundles of product into cases. Case loading system 100 supplies erected cases 90 into a case loading zone by means of conveyor 105 and case positioning device 110, before a case packing operation starts. Case 90 is lifted by indexing fingers assembly 115 and then loaded with folded boxes until a desired number of products are inside the case. The number of products can be predetermined and/or set by the operator. When fully packed, the case is discharged onto the flipping table 120 where it can be picked up or otherwise transported to various locations.

Casing module 100 is built on a frame constructed from common two inch tubular welded steel. Some or all of casing module 100 is constructed at an angle relative to level. Preferably, conveyor 105 and other components of casing module 100 tilt backwards, i.e. downwards from the side of stacker module 6, relative to stacking module 6 and/or collecting table 60 by an angle of approximately 10 degrees, although it is understood that other angles can be used and may be beneficial depending upon the product being based. In any event, orienting portions of casing module 100 at a downward or backward angle can aid in preventing product from sliding out of case 90 after being loaded. The angle also assists in encouraging product to settle towards the back and bottom of case 90. Finally, imparting an angle on case 90 may provide increased control and precision for moving case 90 in when empty, and out after filling.

Casing module 100 also includes case depth adjustment assembly 121, which assists in handling cases of varying sizes. For example, in some embodiments, the front plane of case 90, through which the stacks enter the case, is fixed and does not move. Accordingly, case depth adjustment assembly 121 can be moved manually or via stepper or servo, to position the opening of each case at the desired plane, regardless of the case depth. By fixing the front plane of each case, the system does not have to vary the stroke length of ejector 85, thereby potentially improving cycle time. However, it should be understood that the stroke length of ejector 85 can also be adjusted when desired, such as via movement of a stepper or servo, which may be beneficial in embodiments in which the plane of the back surface of case 90 is fixed.

Conveyor 105 moves empty cases to an area in which casing module 100 loads boxes into the case. As described hereinabove, conveyor 105 may be positioned at an angle, such as 10 degrees, to control the case location. Sensors can be provided to move case 90 forward to the conveyor end when the conveyor is empty. Sensors can also warn the operator when conveyor 105 is empty, such as by turning on a yellow warning light on a light tower. This can be useful so when an operator is running multiple machines, he knows when conveyor 105 needs to be filled. Conveyor 105 may be relatively long, so that it can hold multiple empty boxes. In an exemplary embodiment, conveyor 105 is approximately 6 feet long, in which case the empty case buffer capacity will vary based on the case size. Preferably, the surface of conveyor 105 has relatively low coefficient of sliding friction, so that after one case is moved by conveyor 105 to its end, an operator can continue to put additional empty cases onto conveyor 105 and sliding prior cases over.

In another embodiment, case feeding conveyor 105 can be situated at an elevation above the level at which product is loaded into each case. Thus, each empty case can be dropped into its loading position, rather than raised. Then, as a filled case is lowered onto flipping table 120, a new empty case can be simultaneously dropped into loading position, thereby providing potential reductions in cycle time.

Empty case flap assembly 125 serves to move an empty case into loading position, while full case flap assembly 126 moves a full case out of loading position and onto flipping table 120. Both flap assemblies are pneumatically controlled, driven by a common carrier to contact an exiting full case and an entering empty case, moving along the direction of conveyor 105. While case flap assemblies 125 and 126 are driven by a common carrier, they rotate inwards and extend outwards independently. Therefore, an empty case can be positioned and begin loading simultaneously with the continued movement of a full case onto flipping table 120, thereby reducing cycle time. However, it is understood that in other embodiments, a single assembly could be used to load empty cases and eject full cases. Alternatively, conveyor assemblies and/or a plurality of fully independent pushers could be employed.

Flap assemblies 125 and 126 may optionally include vacuum or clamp attachments to further stabilize and grip each case as the case is moved forward. Furthermore, while flap assemblies 125 and 126 are described as pneumatically-controlled, it is understood that other means of operating such flaps can also be readily employed. For example, without limitation, servo or stepper motors may provide faster and more accurate operation, although in some embodiments they may be more costly than pneumatic control.

A guide rail can also be provided on the stacker side of empty box conveyor 105, which moves with empty case flap assembly 125 to prevent the empty case from rotating and jamming. The guide rail can be particularly beneficial, since empty case flap assembly 125 may be sized for the smallest case, such that larger cases may otherwise not be well-supported during conveyance into loading position. A leading edge of the guide rail may be tapered so that if an operator does not position an empty case squarely or flush against case depth adjustment assembly 121, the guide rail can operate to center the case and prevent a jam.

Casing module 100 also includes case side indexing assembly 130, which has multiple purposes. The primary purpose is for applications in which multiple rows are put into the same case. Case side indexing assembly 130 operates to move case 90 laterally, into a desired position for loading of each row. The secondary purpose is that plates 131 and 132, on the leading and trailing edges of case side indexing assembly 130, each have sensors that assist in the proper positioning of each empty case by empty case flap assembly 125 prior to the lifting of the empty case between the plates. These leading and exit sensors are both used for jam prevention during the lifting cycle. Triggering of either sensor indicates that the box being lifted will not fit and stops the machine. This check can be particularly beneficial during start up, as the operator sets the width for the case. If an operator inadvertently forgets to properly configure a new case width, operation of the sensors on plates 131 and 132 can prevent loss of time and damage to casing module 100. Alternatively, guide plates 131 and 132 can be automatically adjusted for setting the box width using a servo or stepper motor, potentially reducing operator set up effort and possibly eliminating the need for the box detection sensors.

Both guide plates 131 and 132 are attached to pneumatic cylinders which open during the lift cycle and close when the stack is being pushed in. The opening and closing motion centers the case, and maintains the case position more accurately for the movement of the stack into the case.

FIG. 7 illustrates an initial starting point of an exemplary case packing operation, from a side elevation viewpoint. Product stack 150 is positioned on collecting table 60, which is in turn supported by turntable assembly 80. Case 90 rests on indexing fingers assembly 115 in a lowered position.

Ejector 85 includes a pushing member that rests behind product stack 150 in an initial, resting position. Ejector 85 is preferably pneumatically controlled, although other types of ejector assemblies have been implemented using driven belts with side blocks in the newspaper industry. In any event, unlike ejectors typically used in other industries, ejector 85 can be shifted laterally relative to the centerline of product stack 150. Furthermore, the angle of ejector 85 relative to stack 150 may also be changed. By providing for laterally and angular adjustment, ejector 85 can account for offset center of gravity common in products such as auto-bottoms. Also, configuration of ejector 85 to push stack 150 from a position near its center of gravity helps avoid opening of boxes and/or damage to an auto-bottom top flap during a pushing operation.

In place of a pneumatic drive, ejector 85 could also be actuated by a motor, stepper or servo assembly. In applications for which greater operating speed and/or positional requirements may be desired despite potentially higher costs, a servo assembly may be particularly beneficial.

In other embodiments, ejector 85 can be implemented to follow a retraction path that differs from its ejection path. For example, ejector 85 could operate to push stack 150 forwards via movement across the lower chamber, centered near the moment of inertia of stack 150. However, after stack 150 is ejected, ejector 85 can be retracted to its resting position via a path that extends adjacent to, but outside, the lower chamber. By retracting ejector 85 outside the lower chamber, additional product can begin dropping into the lower chamber immediately following the ejection of the prior stack, before ejector 85 has been fully retracted into place, thereby reducing the cycle time.

In yet other embodiments, ejector 85 may include two pusher assemblies, each following a path in which the pusher assembly is retracted along a path outside the lower chamber. Accordingly, while one pusher assembly is ejecting a stack of product, the other pusher assembly is travelling along a retraction path, further reducing the rate at which product stacks can be ejected.

Preferably, ejector 85 can be unlatched and swung out of the way for maintenance operations. This feature may be beneficial in removing jammed cartons, particularly given the rigid nature of typical cartons.

In FIG. 8, case 90 is lifted into loading position by case lifting assembly 115, in which it will receive first stack 150. As case 90 is positioned by case lifting assembly 115, compression fork 155 is extended into case 90. In subsequent stack loading, compression fork 155 presses downwards, to compress previously-loaded stacks and reduce airspace within case 90. However, even for first stack 150, compression fork 155 can operate to create a defined threshold for feeding of stack 150 into case 90.

In addition to the extension of compression fork 155, flexible support fork 156 can also be extended into case 90, just above compression fork 155. Flexible support fork 156 creates a separate between the top of the preceding product stack, if any, and the bottom of the subsequent stack being pushed into the case. This can prevent subsequent stacks from catching on the edges of prior stacks below.

Support fork 156 includes a plurality of long, flexible strips of material which can be curved downwards and underneath collecting table 60, thereby permitting the maintenance of a close proximity between casing station 100 and stacker module 6. Support fork 156 is a long structure that is variably advanced into each case by a distance that can be readily varied, thereby accommodating a variety of product sizes while optionally extending across the entire top surface of a preceding stack, such that prior stacks are held down, even to the extent they may contain edges near the back of the case. This operation may be particularly beneficial when used with product known as four-corner boxes, auto-lock boxes and auto-bottom boxes, which commonly feature edges across varied areas of their top surface.

The depth by which forks 155 and 156 are inserted into a case can be controlled by a variety of advancement mechanisms, including pneumatic cylinders, servos or steppers. After insertion of compression fork 155 and support fork 156, ejector 85 begins pushing stack 150 towards the interior of case 90.

While compression fork 155 and flexible support fork 156 can be actuated during insertion of a first product stack into an empty carton in some embodiments, in other embodiments, it may be desirable to refrain from actuating compression fork 155, support fork 156, either or both, unless and until a first product stack has already been inserted into case 90.

In FIG. 9, stack 150 has been fully ejected into case 90 by ejector 85, and ejector 85 has begun to be retracted. At this point, compression fork 155 and support fork 156 can be subsequently withdrawn from case 90. Optionally, one or more plates can be extended above forks 155 and 156, against the trailing edge of stack 150, thereby preventing any of the cartons within stack 150 from being pulled back out of carton 90 by removal of forks from the case.

Once forks 155 and 156 have been removed from the case, case 90 is lowered until sensor 160 detects that the uppermost level 161 of product within case 90 has been lowered below the level of sensor 160 (FIG. 10). At that point, compression forks 155 are extended (FIG. 11), and case 90 is lifted upwards slightly so that compression forks 155 compress product stack 150 within case 90 (FIG. 12), thereby permitting the filling of more product into each case. A sensor can be provided behind the case, so that if product has filled the entire case but it is desired to load yet another stack into the case, the sensor triggers firing and operation of the compression fork 155. Meanwhile, flexible support fork 156 is extended into case 90 as well, and second product stack 165 is deposited onto collecting table 60. In FIG. 13, ejector 85 advances to push stack 165 into case 90, such that is moves along flexible support forks 156. In FIG. 14, after second product stack 165 has been fully inserted into case 90, ejector 85 is again retracted, and forks 155 and 156 are retracted.

In an exemplary embodiment, forks 155 and/or 156 are at least semi-flexible in the vertical direction, such as forks formed from strips of spring steel or Delrin (also known as polyoxymethylene). In such an embodiment, the forks may be inserted some distance above the preceding stack(s). As a subsequent stack is ejected into the container, the weight of the subsequent stack bends the forks downward against the top surface of the preceding stack, to match the angle of the case and/or the product in the case, which may be different due to the nature of the boxes. Although rigid forks could also be used, rather than flexible or semi-flexible forks, in some applications, the use of rigid forks may increase the space within the case required for reliable operation of the forks, thereby decreasing the amount of product that can be inserted into the case.

In other embodiments, sensor 160, which detects product in a case and activates the compression and support forks, can be moved vertically. This changes the distance between the top of the last stack and the elevation at which the forks are inserted into the case. Such as adjustment of sensor 160 may be beneficial for applications such as auto-bottoms, where the highest edge of the top product may be at a higher elevation than the trailing product edge that is detected by sensor 160. By adjusting sensor 160 upwards, addition elevation margin can be provided to ensure that forks 155 and 156 do not catch a product edge.

In other embodiments, both the flexible support and compression forks are mounted to assemblies that can be repositioned laterally relative to stacks within a case, rather than being centered relative to the case or the support surface. This allows for the fork extensions to be aligned directly with the outside edges of a stack of cartons, and/or with particular carton flaps or edges that may be more likely to catch a subsequent stack entering the case. Furthermore, alignment of the compression fork can be used to prevent the compression fork from missing the edge of a stack of cartons within the case, particularly for small size cartons.

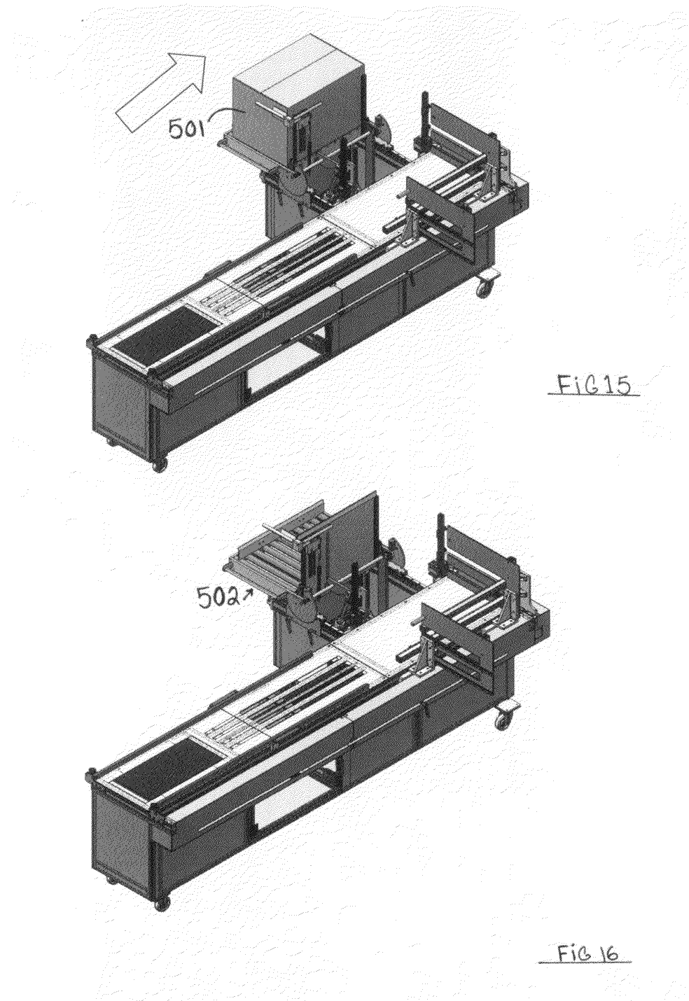

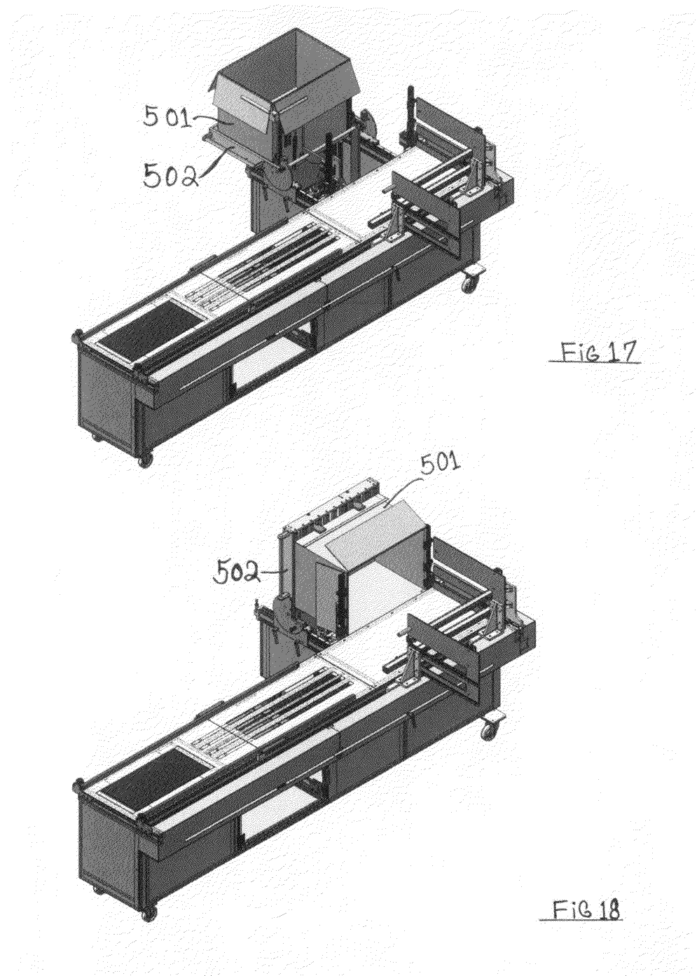

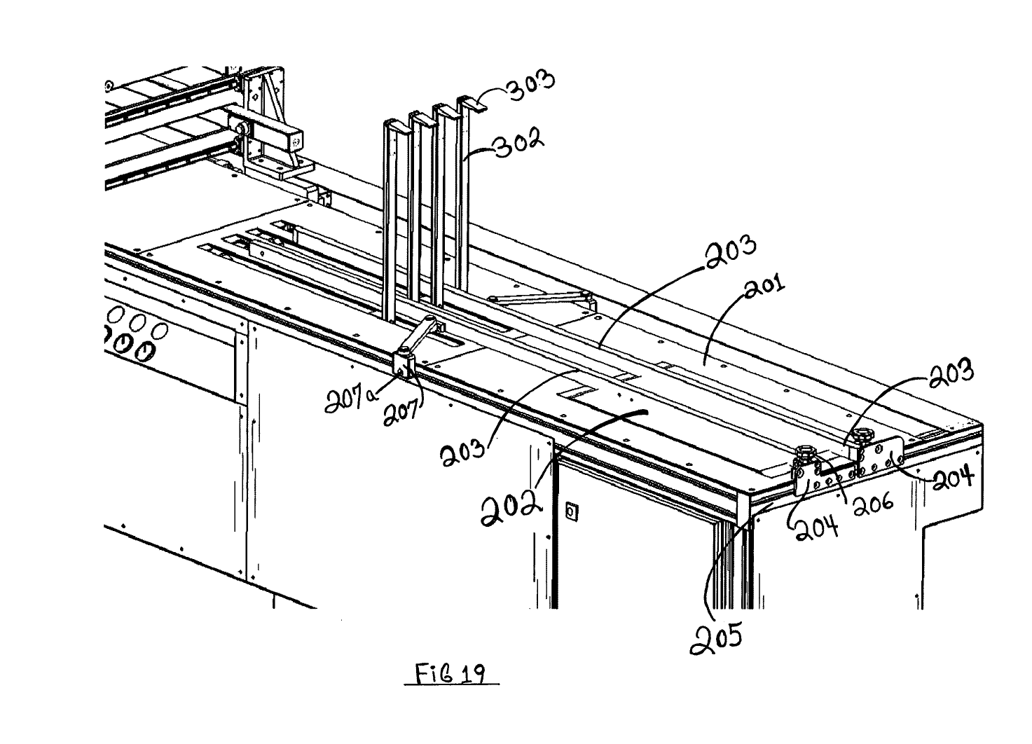

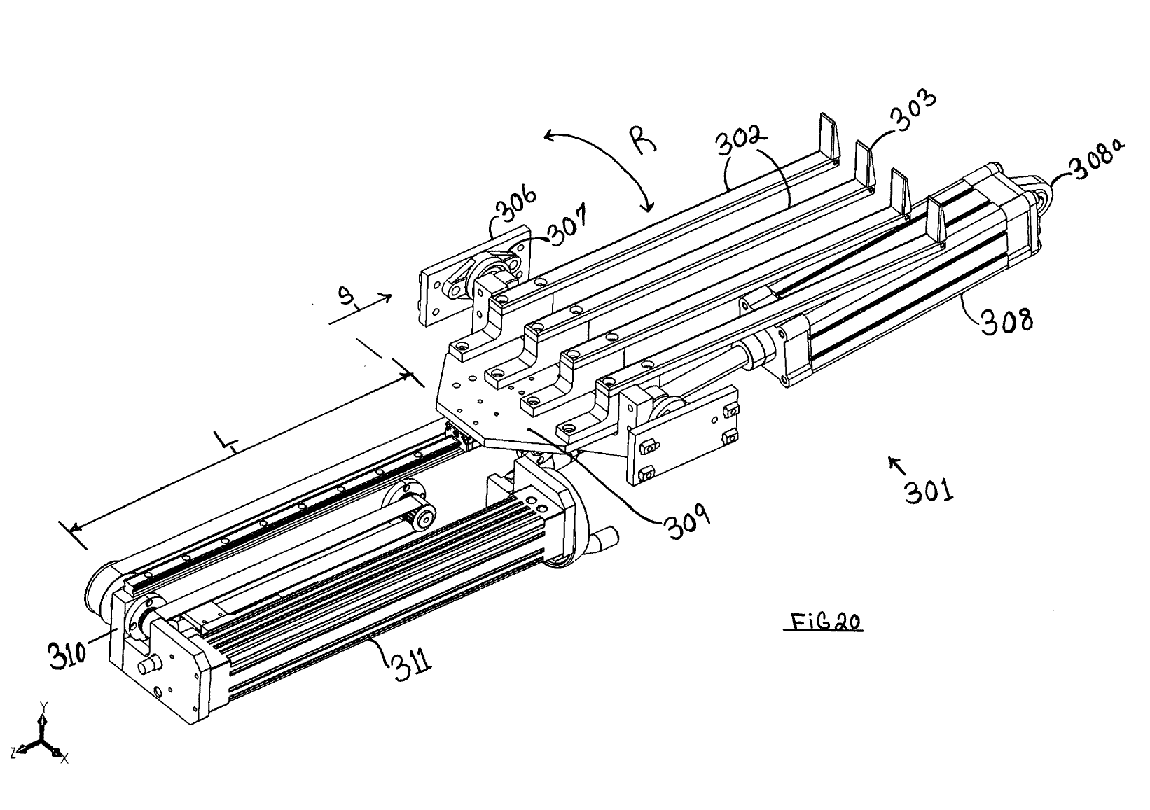

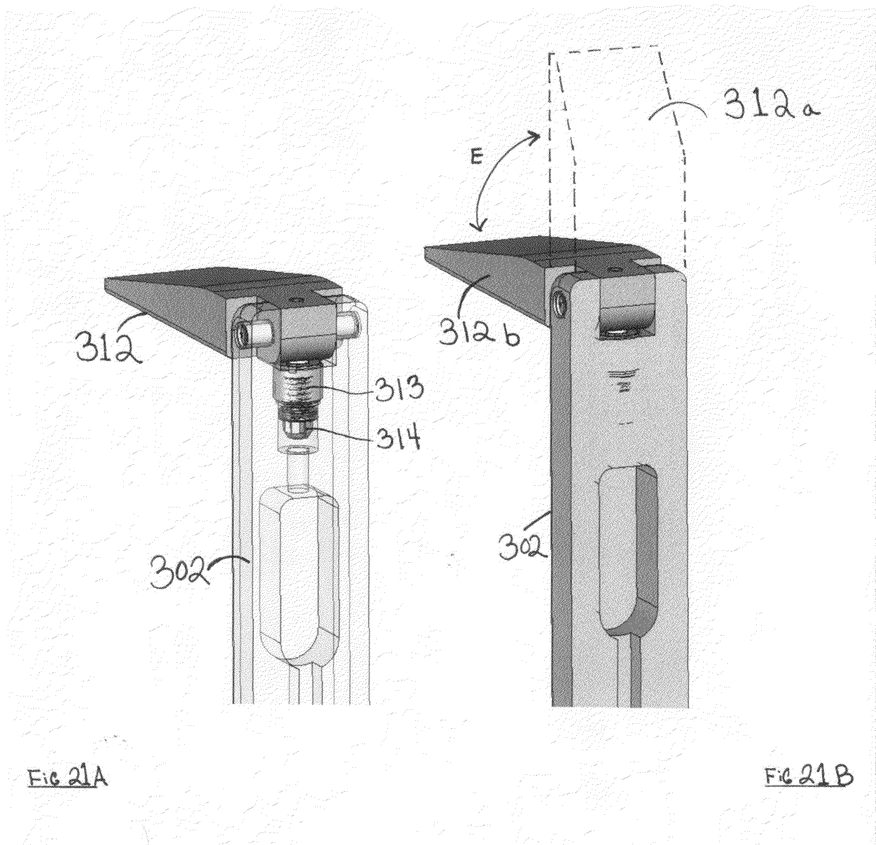

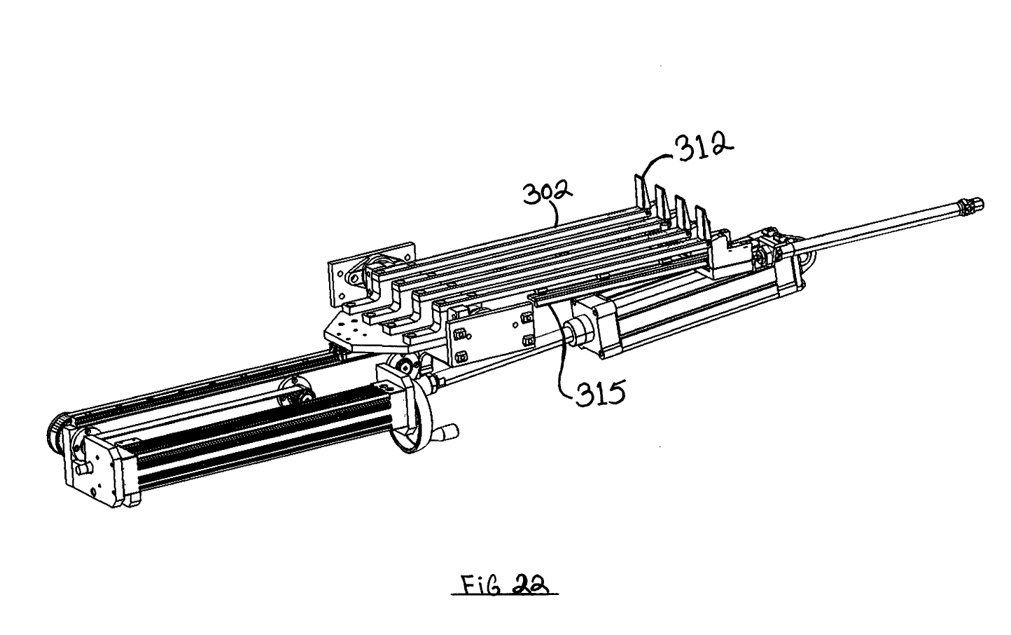

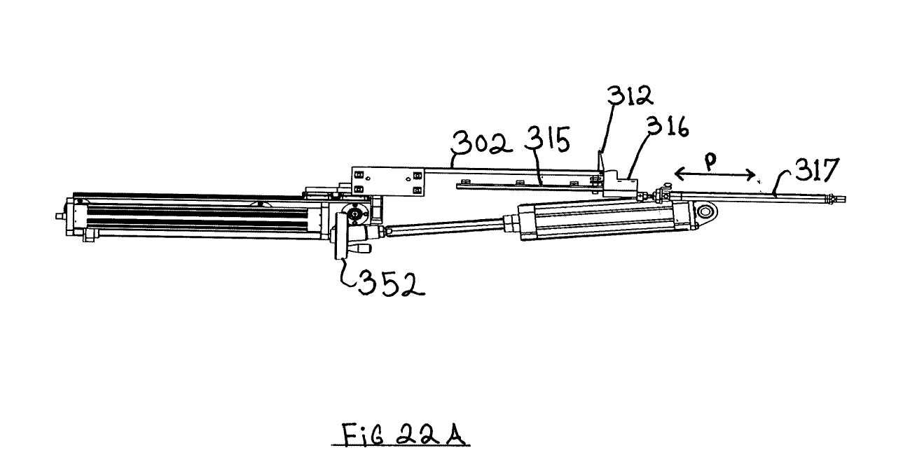

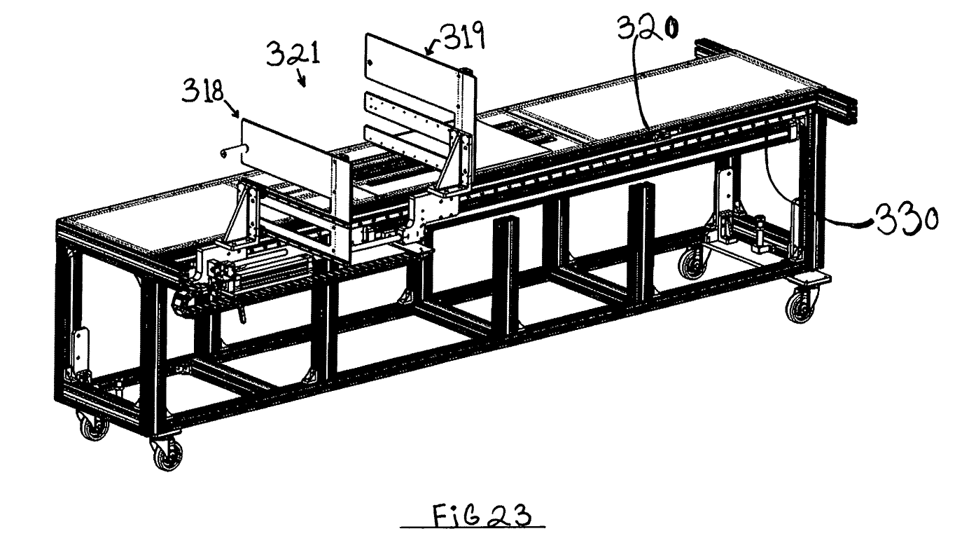

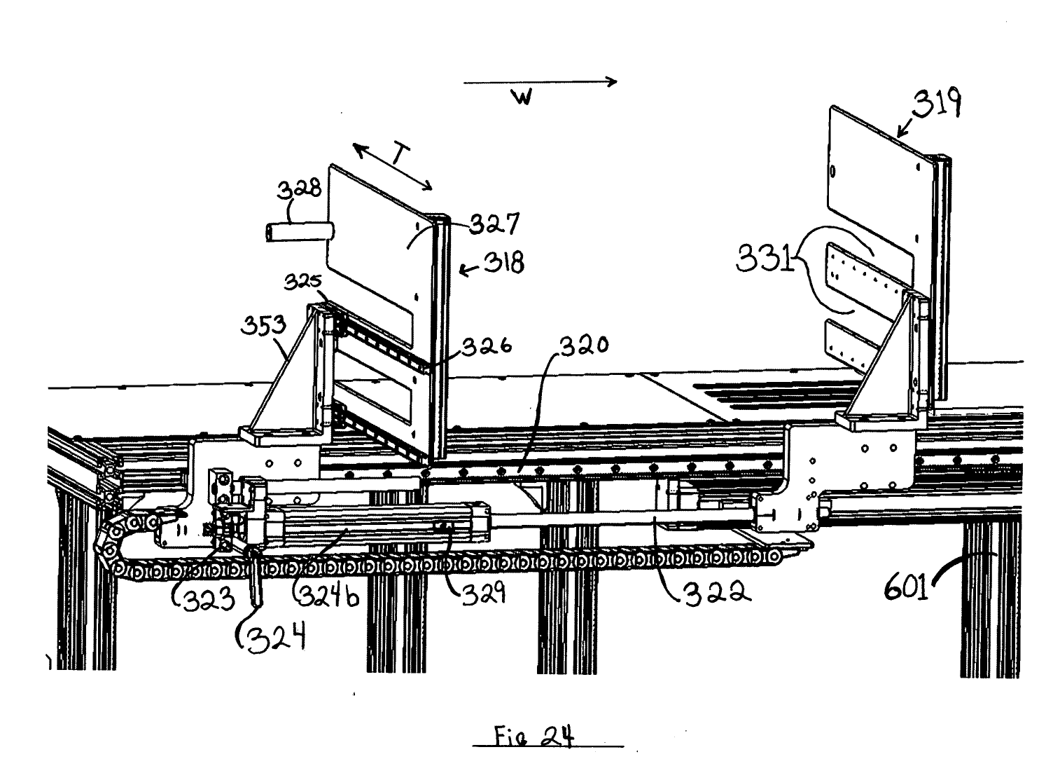

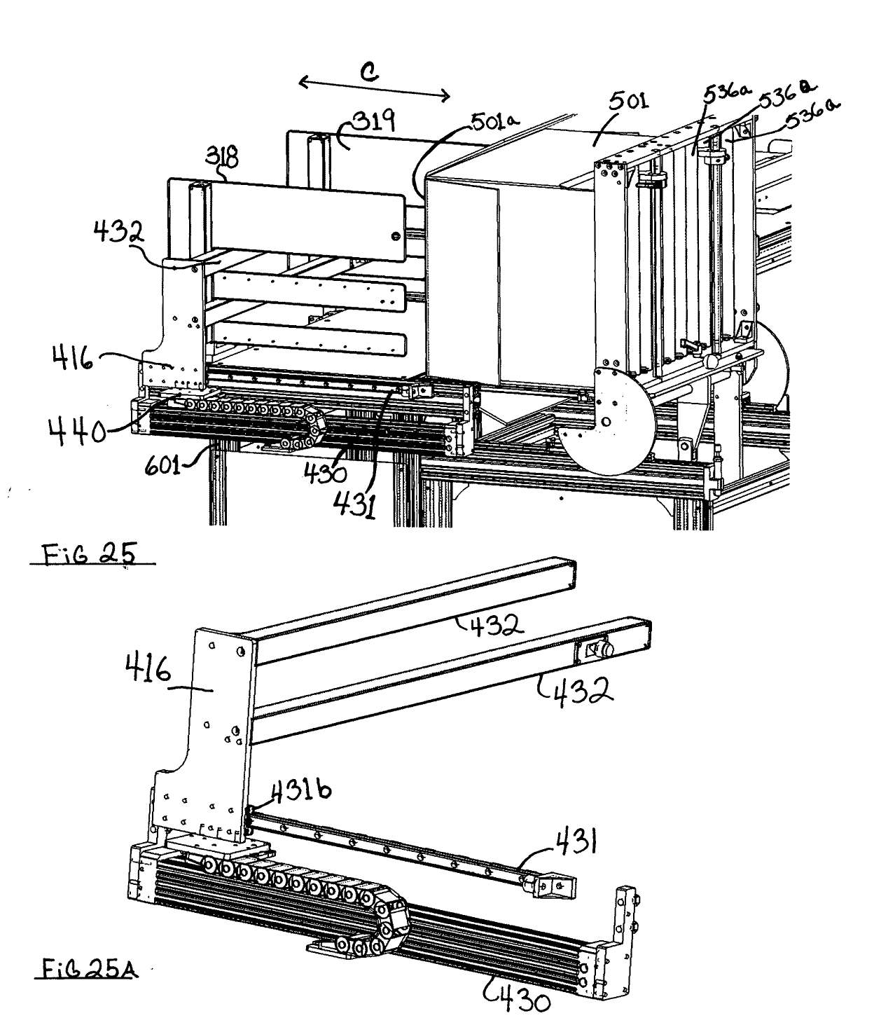

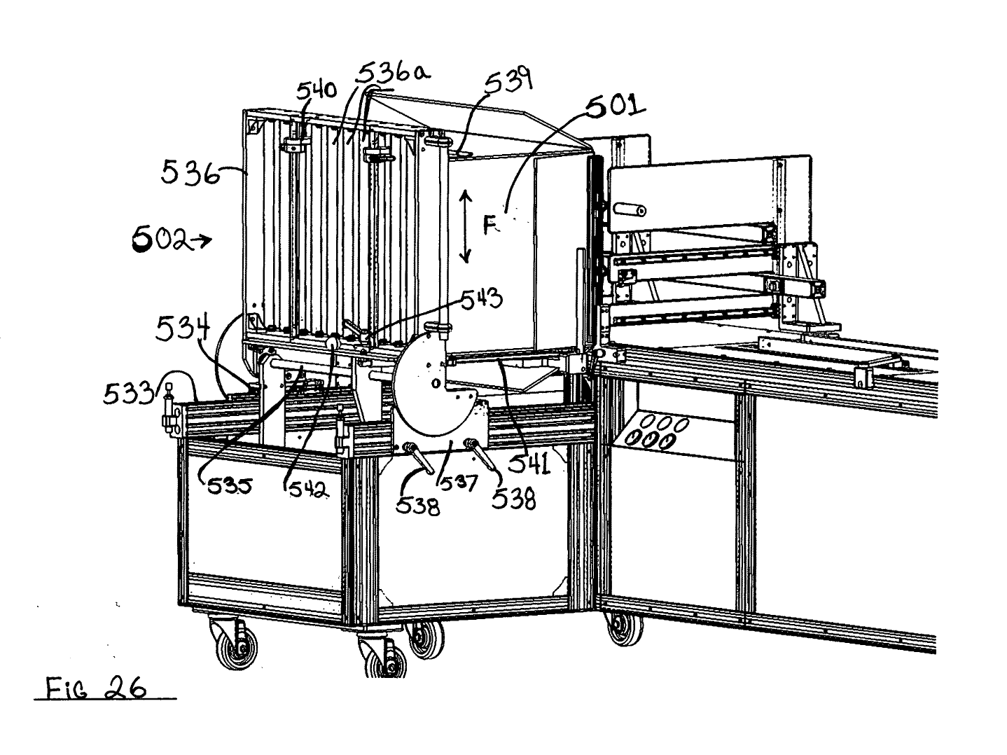

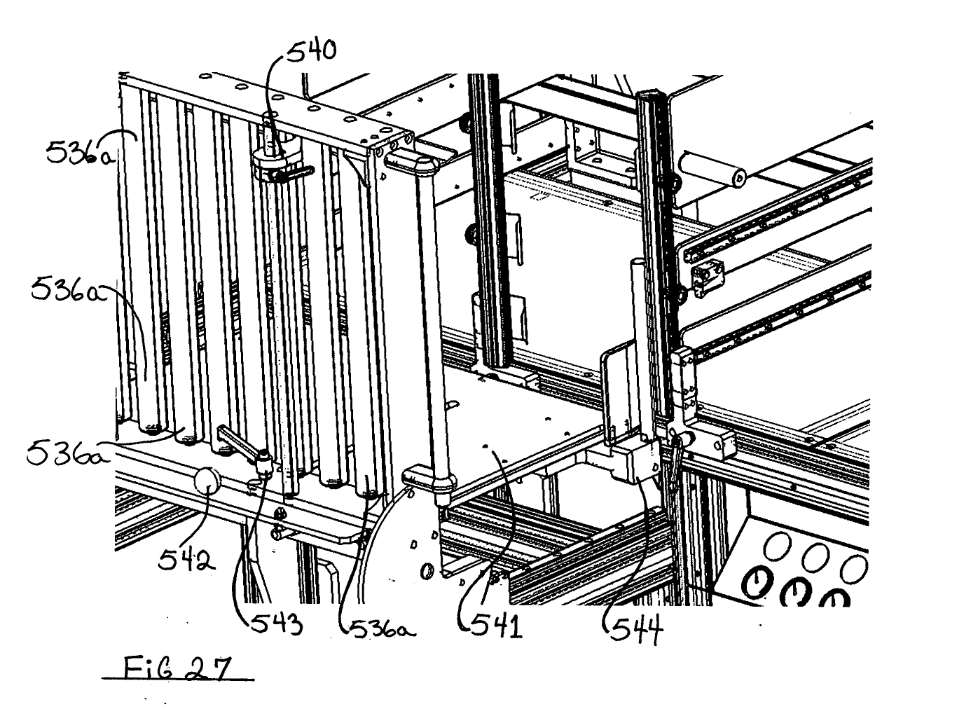

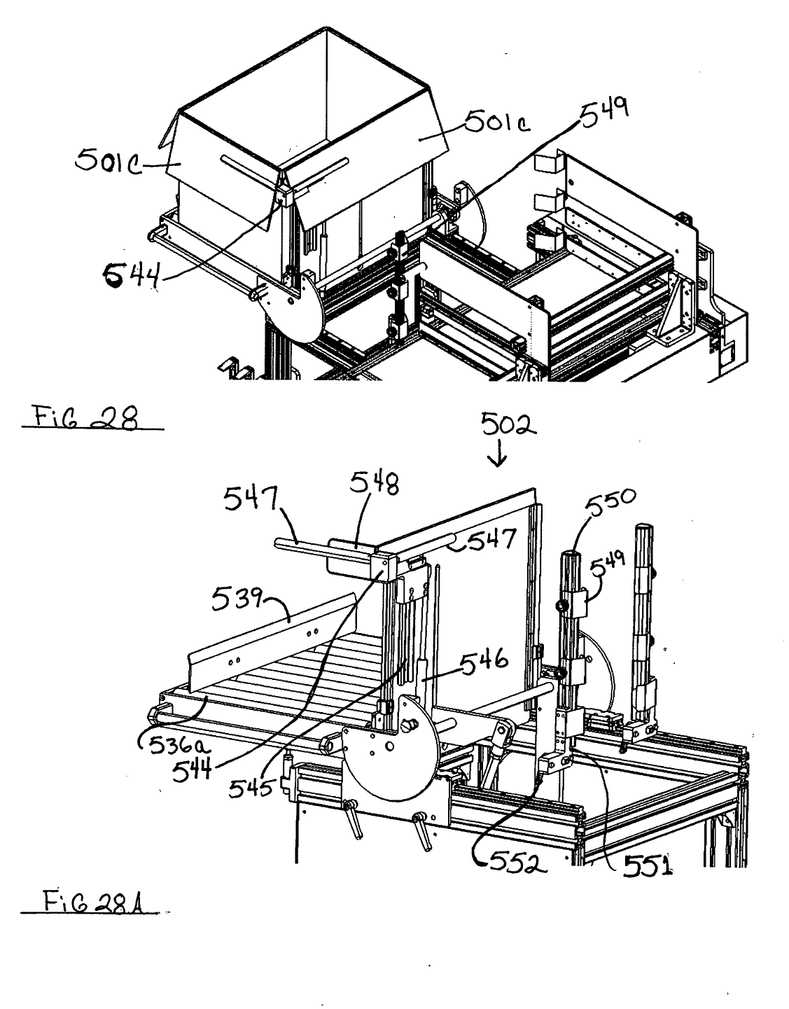

The casing operation illustrated in FIGS. 7-14 can be repeated, until case 90 is filled (FIG. 15), at which point case 90 is lowered and ejected onto flipping table 120. Flipping table 120 can be used to move a full case out of packing module 100. First, flipping table 120 is tilted to bring the full case to an ergonomic work height. In some embodiments, cases may be manually unloaded at this point, such that positioning of the case at an appropriate height for lifting may serve to reduce back strain. In other embodiments, a pusher may move the box out of casing module 100. Gravity, driven rollers or belts can also be employed.

One skilled in the art should readily understand that the systems described herein can be implemented as a single integrated system or separable systems that need not be used together. For example, the stacker and casing assemblies can be separate units that need not be used together. This may be helpful where it is desired to have stacks, yet still maintain manual loading of cases or where stacks are already assembled but just need to be cased.

In accordance with another aspect of the systems described herein, software and methods are provided for optimizing stack building and casing. Optimized stack building for cases and stacks can lead to better packed cases and increased operating and/or utilization speeds.

For example, when building a stack that will be ejected for manual casing, an operator can specify the amount of air (i.e. the air factor) and the system will generate a recommendation for the maximum stack size (count). Being able to run the largest stack possible means that the unit will provide the highest possible throughput. Several pre-set air factors can be employed, based on typical job types, as well as custom settings that permit the operator to measure the product and put in the actual value.

When running product into the casing station, the system can take the information given to the operator for the job which says how much product should go into the case (which may be predetermined as cases are commonly purchased for a specific job). The operator puts in this information as well as the case size and the software then calculates the optimal number of products for each stack, in order to maximize throughput. One aspect is that the software can vary the number of product in the stacks as needed to optimize throughput. The system also gives the operator the ability to manually enter what they want the base stack to be and to see what the pattern will be in the case. This allows the operator to see if there are any stacks that may limit cycle time as well as to see the pattern for quality control.

The software also may permit the operator to rotate the last stack, as described above. It is the ability to control the direction of edges on the bottom of the stack to minimize edges catching on our machine or on the stack below.

The software may also permit the operator to set any stack size, drop the amount of boxes moved from the upper chamber to the lower chamber, and turn to compensate.

The software can also be used to control timing of the grid fingers based on product size. In the system, the operator puts in the product size, which can then be used to vary when the fingers pull out and come in. That way the first set of fingers will better hit the gap and the system can ensure that the lower forks have dropped the product. These changes optimize the quality and the cycle time. With small products, the forks, when pulled out, drop the stack faster, and when coming in, must stroke further before catching the product.

Gap Distance is a control feature that can be used during operation to determine how long a particular product should be gapped by gapper 22. In the commercial printing industry, the gap distance is typically specified as a base time, that is then scaled up or down based on the signature speed. The ability to keep the gap distance and timing consistent as speeds vary is often not precise and typically requires detailed adjustment by the operator during operation. However, the present system uses information, such as the product size, and gaps for a measured distance, rather than a time of operation. The system uses the encoder pulses that track the product moving through the system so the operator can gap for any desired amount. Another advantage of using actual distance is that it is not dependant on the speed at which the product is coming in. This reduces the start up time and tweaking required when speeds are changed on the product line.

The operator has a number of options for how the system interfaces with the product line. For instance, the operator can set the time for when they want a stoppage of the unit to shut down or slow down the product line. The system can give a signal to slow down the product line using the conveyor to buffer product and then at a certain point give a signal to stop the product line, although stopping the product line typically causes waste. In contrast, the present systems generally seek to maximize their throughput.

The system can also display production information. The system shows the job count, products per hour and also gives them a yield. The system allows the operator to set a job start point. At that point the system shows the net yield accounting for all stoppages and other such events. This is very important to production management as the operators normally only see products per hour and associate the maximum number they see with what they are producing when the reality is that it is the net yield that matters. This tool is instrumental at getting the operator to see the importance that keeping the product line and the automation running.

The system is also configured so that, if desired, the system can utilize stepper motors to control all mechanical adjustments. The operator will put in the product size and the machine will adjust accordingly.

The system also has a built in operator interface that has different levels of control, such as password protection for different users.

The system can also include Internet connectivity, which may be desirable for operations such as being able to download and store job specifications. For example, management can log in and see all of the machines running and give key metrics and times for the machines running. Such information can include a speed and time chart, being able to see where stoppages occur and determine if it is in the stacking and casing unit or other unit further up the production line.

Furthermore, the system includes complete error logs with sensors showing diagnostics and pictures of where events occur.

The foregoing description and drawings merely explain and illustrate the invention and the invention is not limited thereto, inasmuch as those skilled in the art, having the present disclosure before them will be able to make modifications and variations therein without departing from the scope of the invention.

I claim:

1. A method for creating a row of folded cartons, comprising the steps of:
sequentially receiving a plurality of folded cartons at an inlet;
separating the cartons creating a row; and
compressing and moving the row of vertical cartons to a position in front of an empty case on is side in a load position.

2. The method of claim 1, further comprising the step for moving the compressed row of cartons laterally into a case on its side in a load position.

3. The method of claim 2, further comprising the step for tilting the full case of cartons from a side load position to an upright position.

4. The method of claim 1, further comprising the step for lifting the cartons from a substantially horizontal position to a vertical position after sequentially receiving a plurality of folded cartons at an inlet.

5. The method of claim 4, further comprising the step for moving the compressed row of cartons laterally into a case on its side in a load position.

6. The method of claim 5, further comprising the step for tilting the full case of cartons from its side in a load position to an upright position.

7. A method for loading a case with folded cartons a row at time by creating a substantively vertical row of folded cartons from either a positive or negative carton stream comprising the steps of:
sequentially receiving a plurality of folded cartons that are in a negative stream at the inlet;
stopping the cartons with raised lifting fingers so that the carton stream will become vertical;
separating the cartons creating a row; and
compressing and moving the row of cartons to a position in front of an empty case on is side in a load position.
Or sequentially receiving a plurality of folded cartons that are in a positive stream at the inlet;
stopping the leading edge of the cartons while lifting the cartons to a vertical position;
separating the cartons creating a row; and
compressing and moving the row of cartons to a position in front of an empty case on is side in a load position.

8. The method of claim 7, further comprising the step for moving the compressed row of cartons laterally into a case on its side in a load position.

9. A system for creating a row of folded cartons, the system comprising:
an adjustable length row clamp used for separating, compressing and moving a row of cartons that are in a vertical orientation; and
a pusher section that moves the row of compressed cartons from the row clamp laterally into a case on its side in a load position.

10. The system of claim 9, further comprising a retractable lifting finger mechanism to either lift the leading edge of a horizontal positive shingle stream into a vertical position or be in a fixed raised position to stop the leading edge of a negative stream which will in turn move the leading cartons in the stream to a vertical position.

11. The system of claim 9, further comprising a tilt station that rotates the full case of cartons from its side in a load position to an upright position.

12. The system of claim 9, in which the row clamp comprises;
a fixed back plate;
a front plate mounted on linear rails to move laterally to contain the row of cartons;
a pneumatic cylinder connecting the front plate to the back plate to compress the row of cartons;
an activation system that is set to allow the front plate to move freely by hand to a set point and then engage the pneumatic cylinder for compression;
a pneumatic cylinder connected to back plate to move the entire row clamp system back to a position to load an empty case on its side.

13. The system of claim 10, in which the lifting section comprises:
a lift mechanism;
a finger plate for mounting a plurality of lifting fingers;
a pneumatic cylinder connected to finger plate through a series of pullies to raise the lifting fingers; and
a pneumatic cylinder connected to the lift mechanism to pivot the assembly from horizontal to vertical.

14. The system in claim 13 in which the lifting finger comprises:
a long main lifting finger with an internal piston a hook that can pivot 90 degrees and can be locked into position by the internal piston in the main lift finger.

15. The system in claim 9 in which the pusher section comprises:
a plurality of pusher bars a pneumatic cylinder connected to the pusher bars to move them laterally between the front and back plates on the row clamp toward a case on its side in a load position.

16. The system in claim 11 in which the tilt station comprises:
a plurality of rollers in the direction of the full case eject with linear adjustment for case size;
a rotational shaft;
a pneumatic cylinder connected to the rotational shaft to balance the weight of the full case and the tilt table. The pneumatic cylinder allows the tilt station to move the case from a side load position to an upright position.

17. A system for creating a row of folded cartons and moving the row into an empty case, the system comprising:
an infeed consisting of a conveyor on which folded cartons are fed;
a retractable, pivoting, lifting finger mechanism to either lift the leading edge of a horizontal positive shingle stream into a vertical position or be in a fixed raised position to stop the leading edge of a negative stream which will in turn move the leading cartons in the stream to a vertical position.
a pusher section that moves the row of compressed cartons from the row clamp laterally into a case on its side in a load position;
a tilt station that rotates the full case from a side load position to an upright position;
an adjustable length row clamp used for separating, compressing and moving a row of cartons that are in a vertical orientation comprised of:
a fixed back plate;
a front plate mounted on linear rails to move laterally to contain the row of cartons;
a pneumatic cylinder connecting the front plate to the back plate to compress the row of cartons;
an activation system that is set to allow the front plate to move freely by hand to a set point and then engage the pneumatic cylinder for compression; and
a pneumatic cylinder connected to back plate to move the entire row clamp system back to a position to load an empty case.

18. The system of claim 17, in which the lifting station comprises:
a lift mechanism;
a finger plate for mounting a plurality of fingers;
a pneumatic cylinder connected to finger plate through a series of pullies to raise the fingers; and
a pneumatic cylinder connected to the lift mechanism to pivot the assembly from horizontal to vertical.

19. The system in claim 17 in which the lifting finger comprises:
a long main finger with an internal piston a hook that can pivot 90 degrees and can be locked into position by the internal piston in the main finger.

20. The system in claim 17 in which the pusher section comprises:
a plurality of pusher bars a pneumatic cylinder connected to the pusher bars to move them laterally between the front and back plates on the row clamp system towards a case on its side in a load position.

21. The system in claim 17 in which the tilt station comprises:
a plurality of rollers with linear adjustment for case size;
a rotational shaft;
a pneumatic cylinder connected to the rotational shaft to balance the weight of the full case and the tilt table. The pneumatic cylinder allows the tilt station to move from vertical to horizontal
